(19) United States
(12) Patent Application Publication
(10) Pub. No.: US 2018/0011187 A1
(43) Pub. Date: Jan. 11, 2018

(54) SYNTHETIC-APERTURE RADAR SIGNAL PROCESSING APPARATUS

(71) Applicant: Mitsubishi Electric Corporation, Chiyoda-ku, Tokyo (JP)

(72) Inventors: Yumiko KATAYAMA, Chiyoda-ku (JP); Noboru OISHI, Chiyoda-ku (JP)

(73) Assignee: Mitsubishi Electric Corporation, Chiyoda-ku, Tokyo (JP)

(21) Appl. No.: 15/544,278

(22) PCT Filed: Feb. 6, 2015
(86) PCT No.: PCT/JP2015/000549

§ 371 Date: Jul. 18, 2017

(51) Int. Cl. G01S 13/90

(52) U.S. Cl. CPC G01S 13/9023

(57) ABSTRACT

A synthetic-aperture radar signal processing apparatus in accordance with the present invention estimates the height of a scatterer in a synthetic aperture radar image observed at sets of sensors, each corresponding to a baseline length, and extracts a pixel corresponding to the scatterer at the height from the synthetic aperture radar image. The synthetic-aperture radar signal processing apparatus generates a topographic fringe of the synthetic aperture radar image calculates the phase of the topographic fringe that correspond to the specific height, and then extracts a pixel having the phase from the topographic fringe, resulting in the extraction of the pixel at the specific height. This configuration can extract a specific height corresponding to a combination of the phases generated by multiple topographic fringes and measure the height of the scatterer where the two sensors having the shortest baseline determine a measurable height.

### TECHNICAL FIELD

The present invention relates to a signal processing apparatus for use in a synthetic aperture radar.

### BACKGROUND ART

A synthetic aperture radar (SAR) signal processing apparatus transmits pulse waves and receives reflected signals from a scatterer. The SAR signal processing apparatus can measure the distance from a platform equipped with the SAR (e.g. artificial satellite) to a scatterer using the data of the time when the reflected signals are received from the scatterer, and has a resolution in the range direction of the radio wave radiation. The SAR platform can transmit and receive the radio waves while moving and thus can function as a virtual antenna with a large aperture in its moving direction. The platform has a resolution in the azimuth direction i.e., its moving direction. An SAR image created from the received signals of the SAR consists or multiple pixels each having the data of the phase and amplitude of the received signal.

FIG. 29 is a conceptual diagram illustrating the concept of an interference phase in the SAR in the prior art. Referring to FIG. 29, the relation between the interference phase and the height will now be described below. A platform is assumed to be moving from the front to the back of the drawing plane, indicating that the azimuth direction is directed from the front to the back of the drawing place. FIG. 29 also illustrates the ground-range direction and the height direction, each corresponding to the direction of the radio wave radiation.

Assuming that SAR images are captured at k1 and k2 each representing the orbital position of the platform, the difference in reception phase between the two reflected signals from the scatterer, i.e., the phase difference of each pixel between the two SAR images, has a proportional relation with the difference between the distance from the orbital position k1 of the platform to the scatterer and the distance from the orbital position k2 of the platform to the scatterer (k2 has a different position from k1). It is noted that the phase has a value wrapped by 2π. The relation between the topographic fringe φz calculated by subtracting the orbital fringes of the two orbital positions from the phase difference and the height z of the scatterer is defined by Expression (1);

φz=W{(2π·p·B/λ·R·sin θ)·z} (1)
where { }: the wrapping by 2π,
p: the coefficient representing an observation mode (p=1 for the single-pass mode, and p=2 for the repeat-pass mode),
λ: the wavelength of radiated radio waves,
θ: the off-nadir angle of radiated radio waves,
R: the distance from the center point between the orbital position k1 and the orbital position k2 to the center point of the image, and
B: the length of the orthographic baseline of the orbital position k1 and the orbital position k2,
where φz is in proportion to z. It is noted that the phase has a value wrapped by 2π. Hereinafter, the orthographic baseline is referred to simply as “baseline”. Since any other scatterer at the same height z has the same phase φz of the topographic fringe, the height of the scatterer can be estimated using the phase of the topographic fringe in the SAR observed image. In addition, the SAR image is converted into a three-dimensional image through estimation of the heights of all the scatterers in the SAR image.

This proportional relation between the topographic fringe φz and the height z of the scatterer varies depending on the length of the baseline B (hereinafter a “baseline length”). As the baseline length B decreases, the resolution of the height decreases although the different heights of the scatterers having high heights can be readily discriminated from each other. As the baseline length B increases, the resolution of the height increases although the wrapping causes the scatterers at different heights to have the identical interference phase, resulting in multiple heights of the scatterer z each corresponding to the identical interference phase (this is called “height ambiguity”).

In the method of Multi-Baseline InSAR (Interferometric SAR) using the interference phases of different sets of SAR images with different baselines, an approximate height of the scatterer in the SAR image is estimated from the phase difference between a set of SAR images with a short baseline B, and then the accuracy of the height estimate is improved using the phase difference between another set of SAR images with a long baseline (for example, refer to Non-Patent Literature 1). Another method is also proposed to form a virtual beam and have a resolution in the height direction by digital beam forming in the tomography SAR using different sets of SAR images with different baselines (for example, refer to Non-Patent Literatures 2). In these traditional techniques, the highest presumable height zmax of the scatterer is defined by Expression (2):

zmax=(λ·R·sin θ)/(p·B) (2)

where B is the shortest baseline length among the different baseline lengths.

### CITATION LIST

### Non Patent Literature

Non-Patent Literature 1: Douglas G. Thompson, Multi-Baseline Interferometric SAR for Iterative High Estimation, IEEE 1999 International1, 1933, 251-253.

Non-Patent Literature 2; A. Reigber, First demonstration of airborne SAR tomography using multibaseline L-band data, IEEE Transactions on Geoscience Remote Sensing 38, 2000/9, 2142-2152.

### SUMMARY OF INVENTION

### Technical Problem

The traditional synthetic-aperture radar signal processing apparatuses cannot estimate heights of scatterers higher than the height zmax of Expression (2) that corresponds to the shortest baseline length in the SAR image. This indicates that the height z can be uniquely specified from the topographic fringe φz if the highest height of the scatterers in the SAR image is known to be equal to or lower than zmax. However, it is difficult to specify a height from the topographic fringe if the highest height of the scatterers in the SAR image is unknown or known to be equal to or higher than zmax. An object of the present invention, which has been accomplished to solve these problems, is to provide a synthetic-aperture radar signal processing apparatus that can estimate the heights of the scatterers, the heights being equal to or higher than the height zmax of Expression (2) that corresponds to the shortest baseline length, in the SAR image, and extract the images of the scatterers.

### Solution to Problem

The synthetic-aperture radar signal processing apparatus in accordance with the present invention includes an interference phase processor configured to calculate a first topographic fringe represented by multiple pixels, representing a relative phase between signals contained in two pixels representing the same scatterer in a first set of two synthetic aperture radar images using the first set of two synthetic aperture radar images generated by two sensors having a first baseline length, and calculate a second topographic fringe represented by multiple pixels, representing a relative phase between signals contained in two pixels representing the same scatterer in a second set of two synthetic aperture radar images using the second set of two synthetic aperture radar images generated by two sensors having a second baseline length, and further includes an extraction processor which has a phase calculator configured to calculate a first specific phase that corresponds to a scatterer at at least one specific height in the first topographic fringe and a second specific phase that corresponds to the scatterer at the at least one specific height in the second topographic fringe, and has a pixel extractor configured to extract a pixel corresponding to the at least one specific height from the first topographic fringe and the second topographic fringe, the pixel having the first specific phase in the first topographic fringe and the second specific phase in the second topographic fringe. The first and second topographic fringes are calculated at the interference phase processor.

### Advantageous Effects of Invention

The synthetic-aperture radar signal processing apparatus of the present invention can extract pixels of the scatterers at specified heights where the scatterers are higher than those measurable by the two sensors having the shortest baseline length among the different baseline lengths.

### BRIEF DESCRIPTION OF DRAWINGS

FIG. 1 is an overall configuration diagram illustrating a 3D image generating unit 1000 for the SAR images in accordance with the first embodiment.

FIG. 2 is a functional block diagram illustrating the functions of an interference phase processor 1050 in accordance with the first embodiment.

FIG. 3 is a functional block diagram illustrating the functions of an extraction processor 1070 in accordance with the first embodiment.

FIG. 4 is a functional block diagram illustrating the functions of a signal synthesizer 1090 in accordance with the first embodiment.

FIG. 5 is a flow chart illustrating the operations of a 3D image generating unit 1000 for the SAR image in accordance with the first embodiment.

FIG. 6 is a conceptual diagram illustrating the concept of an interference phase in the SAR in accordance with the first embodiment.

FIG. 7 is a flow chart illustrating the process of Step ST1050 (interference phase processing) in accordance with the first embodiment.

FIGS. 8A to 8C illustrate the relations between the topographic fringe and the height in two sets of SAR images in accordance with the first embodiment.

FIGS. 9A and 9B illustrate exemplary signals of each pixel in a complex plane when the topographic fringe is processed as a complex number in accordance with the first embodiment.

FIG. 10 illustrates an example of a filter in accordance with the first embodiment.

FIG. 11. illustrates exemplary arrays corresponding to the pixels of each topographic fringe in accordance with the first embodiment.

FIG. 12 is a flow chart illustrating the process of Step ST1070 (extraction processing) in accordance with the first embodiment.

FIG. 13 is a conceptual diagram illustrating the concept of the foreshortening in the SAR image in accordance with the first embodiment.

FIGS. 14A and 14B illustrate exemplary 3D SAR images in accordance with the first embodiment.

FIG. 15 is a flow chart illustrating the process of Step ST1090 (signal synthesis) in accordance with the first embodiment.

FIG. 16 is an overall configuration diagram of a device that estimates the height of the scatterer in the SAR image in accordance with the second embodiment.

FIG. 17 is a functional block diagram illustrating the functions of an interference phase processor 2020 in accordance with the second embodiment.

FIG. 18 is a functional block diagram illustrating the functions of an extraction processor 2040 in accordance with the second embodiment.

FIG. 19 is a flow chart illustrating the operation of a height estimating system 2000 for the scatterer in the SAR image in accordance with the second embodiment.

FIGS. 20A to 20C illustrate respective exemplary variations of the interference phase, the phase of the orbital fringe and the phase of the topographic fringe which are formed with the two SAR images in the ground-range direction in accordance with the second embodiment.

FIG. 21 is a flow chart illustrating the process of Step ST2020 (interference phase processing) in accordance with the second embodiment.

FIG. 22 is a flow chart illustrating the process of Step ST2040 (extraction processing) in accordance with the second embodiment.

FIG. 23 is an overall configuration diagram of a device that extracts scatterers at the same height in the SAR image in accordance with the third embodiment.

FIG. 24 is a functional block diagram illustrating the functions of an extraction processor 3020 in accordance with the third embodiment.

FIG. 25 is a functional block diagram illustrating the functions of a GCP-height data detector 3030 in accordance with the third embodiment.

FIG. 26 is a functional block diagram illustrating the functions of a signal synthesizer 3040 in accordance with the third embodiment.

FIG. 27 is a flow chart illustrating the operations of an extraction unit 3000 that extracts scatterers at the same height in the SAR image in accordance with the third embodiment.

FIG. 28 is a flow chart illustrating the process of Step ST3020 (extraction processing) in accordance with the third embodiment.

FIG. 29 is a conceptual diagram illustrating an interference phase of the synthetic aperture radar in the prior art.

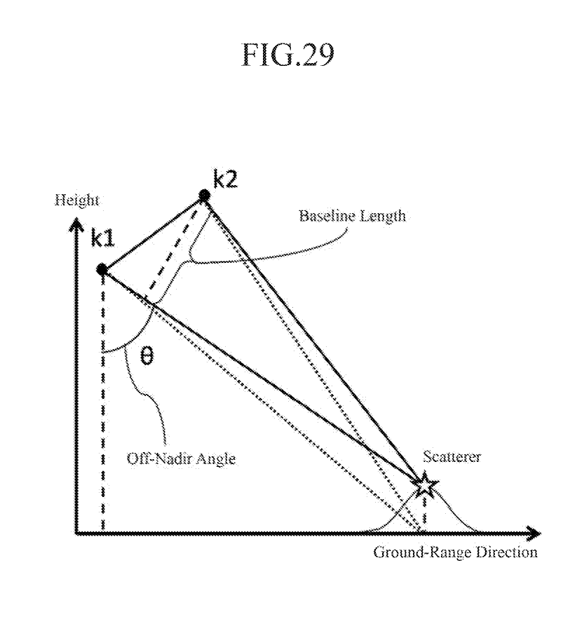

### DESCRIPTION OF EMBODIMENTS

The embodiments, i.e. the first to third embodiments of the present invention will now be described in sequence in detail with reference to the drawings.

### First Embodiment

In the first embodiment, a synthetic-aperture radar signal processing apparatus is described that processes signals using multiple sets of SAR images with different baselines (including the cartographic information of each pixel) and the information (latitude, longitude, or map coordinates and height) on the orbital positions of the sensor that has captured all the SAR images.

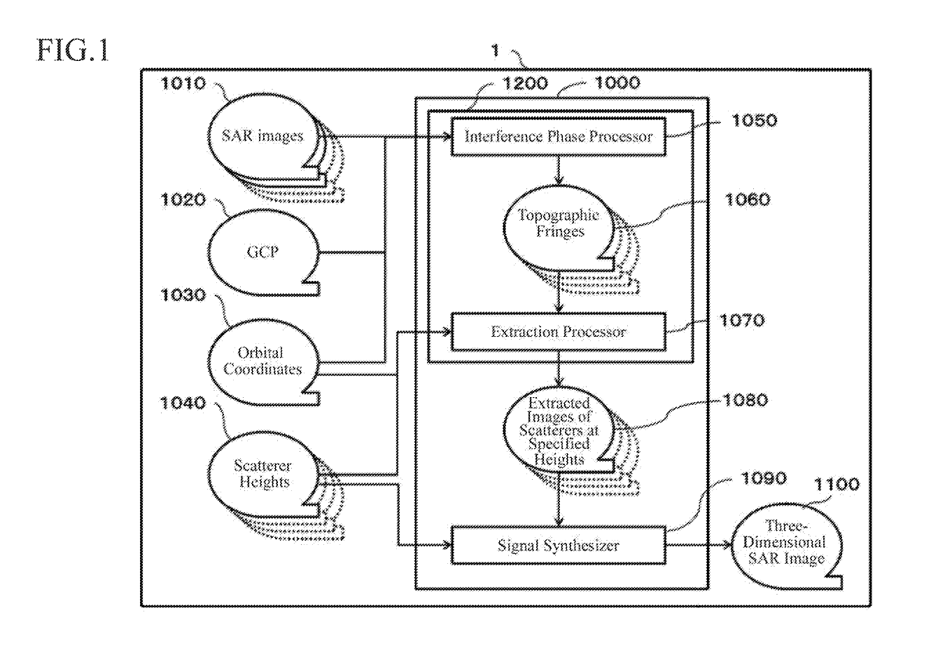

FIG. 1 is an overall configuration diagram illustrating a 3D image generating unit 1000 of a synthetic-aperture radar signal processing apparatus 1 in accordance with the first embodiment. With reference to FIG. 1, the outline of the synthetic-aperture radar signal processing apparatus 1, a 3D image generating unit 1000 in the SAR image, and a scatterer-height estimating unit 1200 will be described in accordance with the first embodiment.

In FIG. 1, the synthetic-aperture radar signal processing apparatus 1 includes a 3D image generating unit 1000, and SAR images 1010, a GCP 1020, orbital coordinates 1030, and scatterer heights 1040. The 3D image generating unit 1000 includes a scatterer-height estimating unit 1200 having an interference phase processor 1050 and an extraction processor 1070, and a signal synthesizer 1090. The interference phase processor 1050 removes the orbital fringe. The interference phase processor receives two SAR images from among the SAR images 1010, a GCP (Ground Control Point) 1020, and the orbital coordinates 1030, and outputs topographic fringes 1060 corresponding to the sets of two SAR images. The extraction processor 1070 extracts scatterers at specific heights. The extraction processor receives the topographic fringes 1060, the orbital coordinates 1030, and the scatterer heights 1040, and outputs extracted images 1080 of scatterers at specified heights (hereinafter “extracted images 1080”) at the specified heights. The signal synthesizer 1090 outputs a three-dimensional SAR image. The signal synthesizer receives the scatterer heights 1040 and the extracted images 1080, and outputs the three-dimensional SAR image 1100.

In the first embodiment, the interference phase processor 1050 receives three or more SAR images from among the SAR images 1010, and generates two or more sets of topographic fringes 1060. All the SAR images 1010 are assumed to be obtained by capturing the same area under the same mode and the same off-nadir angle, and have gone through the alignment or registration process. All the SAR images 1010 consist of multiple pixels, each providing the cartographic information (e.g. latitude, longitude, or map coordinates).

The GCP 1020 indicates the data of the coordinates of three or more pixels in the SAR images 1010. The GCP corresponds to known scatterers on the ground surface, each having no overlapping of multiple signals. The orbital coordinates 1030 are the data of the orbital position (latitude, longitude, or map coordinates and height) of the sensor that has captured the SAR images 1010.

The scatterer heights 1040 are the data of user-specified heights of scatterers to be extracted. The extraction processor 1070 outputs the SAR images (the extracted images 1080) that have extracted the scatterers at the heights specified by the scatterer heights 1040. In the case where the height of the scatterer to be extracted is known, this height is defined as the scatterer heights 1040 and the extraction processor 1070 extracts the signals of the scatterer at this height. In the case where the height of the scatterer to be extracted is unknown, multiple heights as the scatterer heights 1040 are specified and the extraction processor 1070 repeats the extraction process at the specified heights to extract the signals of the scatterers at each specified height. The extraction processor 1070 outputs the extracted images 1080 according to the number of heights specified by the user.

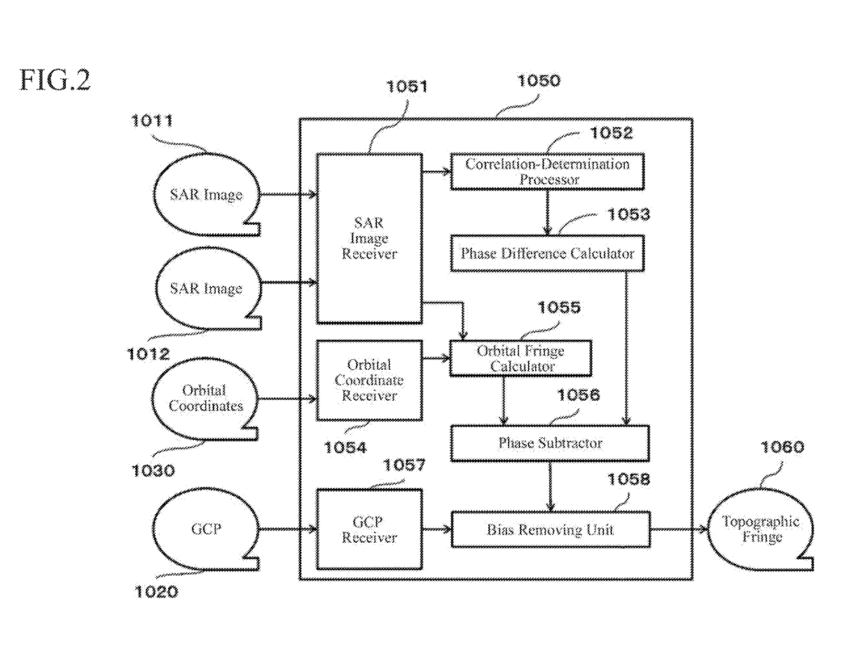

FIG. 2 is a functional block diagram illustrating the functions of the interference phase processor 1050. With reference to FIG. 2, the functions of the interference phase processor 1050 will now be described. The interference phase processor 1050 includes an SAR image receiver 1051, a correlation-determination processor 1052, a phase difference calculator 1053, an orbital coordinate receiver 1054, an orbital fringe calculator 1055, a phase subtractor 1056, a GCP receiver 1057, and a bias removing unit 1058. The SAR image receiver 1051 receives multiple SAR images 1010 (including the signal information of each pixel in the SAR image and the cartographic information of each pixel in the SAR image). The SAR images of the identical location have been captured by the synthetic aperture radar at different orbital positions.

The SAR image receiver 1051 usually receives three or more SAR images 1010. For ease of description, the interference phase processor 1050 is assumed to receive two SAR images, i.e., the SAR image 1011 and the SAR image 1012. The SAR image 1011 and the SAR image 1012 are assumed to have a baseline B equal to or less than the critical baseline Bc that is defined by Expression (3):

Bc=(λ·R·tan θ)/p·r (3)

where r: the ground-range resolution.

The correlation-determination processor 1052 specifies two SAR images from among the SAR images 1010 received at the SAR image receiver 1051, determines whether each pixel has signal overlapping through the correlation processes between each set of SAR images, and outputs the results. For example, the pixel with a high correlation is determined to have a single signal whereas the pixel with a low correlation is determined to have multiple overlapping signals. As examples of the signal overlapping in the pixels, effects such as layover possibly occur on an SAR image where the reflected signals from buildings overlap the reflected signals from the ground. The following processes are performed for the pixels having a single signal.

The phase difference calculator 1053 calculates the difference in phase (interference phase) in the signal information for each set of pixels between the SAR image 1011 and the SAR image 1012 received at the SAR image receiver 1051. The data outputted from the phase difference calculator also include the data of the signal amplitude. For example, in the case where the signal information received from the SAR image receiver 1051 includes the data of complex numbers, the phase difference calculator outputs the product of the complex number of the signal of a pixel in one SAR image and the conjugate complex number of the signal of the corresponding pixel in the other SAR image. The product of the complex numbers has an absolute value representing the product of the signal amplitude in the SAR images and an argument representing an interference phase. The phase difference calculator 1053 receives the SAR image 1011 and the SAR image 1012, and outputs the interference phase and the signal amplitude of each pixel.

The orbital coordinate receiver 1054 receives the orbital coordinates 1030. The orbital coordinates indicate the data of two orbital positions (latitude, longitude, or map coordinates and height) of the sensor that has captured the SAR image 1011 and the SAR image 1012. The orbital fringe calculator 1055 calculates the phase of the orbital fringe for each pixel using the cartographic information (latitude, longitude, or map coordinate) of each pixel in the SAR image and the orbital position information on the sensor that has captured the SAR image 1011 and the SAR image 1012, each being received at the orbital coordinate receiver 1054. The orbital fringe calculator 1055 receives the cartographic information of each pixel in the SAR image and the orbital position information on the sensor that has captured the SAR image 1011 and the SAR image 1012, and outputs the orbital fringe of the SAR image using the set of the SAR image 1011 and the SAR image 1012.

The phase subtractor 1056 subtracts the orbital fringe from the interference phase (the difference is called corrected interference phase) for each pixel in the SAR image using the interference phases of the signals of the SAR image 1011 and the SAE image 1012 that have been calculated at the phase difference calculator 1053, and the orbital fringe using the set of the SAR image 1011 and the SAR image 1012 that have been calculated at the orbital fringe calculator 1055. The phase subtractor 1056 receives the interference phase and the orbital fringe using the set of the SAR image 1011 and the SAR image 1012, and outputs the corrected interference phase. The data of the corrected interference phase includes the signal amplitude data outputted from the phase difference calculator 1053, and holds the signal amplitude data unchanged. For example, in the case where the phase difference calculator 1053 calculates the product of a complex number and a conjugate complex number, the phase subtractor loss holds the amplitude data unchanged and changes only the argument of the phase.

The GCP receiver 1057 receives the GCP 1020 that is the data of the coordinates of three or more pixels (the pixels of known scatterers on the ground surface, each having no overlapping of multiple signals) in the SAR image 1011 and the SAR image 1012. The bias removing unit 1058 calculates the topographic fringes 1060 as follows: The bias removing unit generates the phase plane having the phases of three or more GCP coordinates using three or more coordinates received at the GCP receiver 1057 and the distribution of the corrected interference phases calculated at the phase subtractor 1056, and then correct the phases of the overall phase plane to have the same phase over the phase plane. The bias removing unit 1058 receives the coordinate data of the GCP 1020 and the corrected interference phase, and outputs the topographic fringes 1060. The topographic fringe 1050 holds the signal amplitude data output ted from the phase subtractor 1056 without any change. For example, in the case where the phase difference calculator 1053 calculates the product of a complex number and a conjugate complex number, the bias removing unit 1058 holds the amplitude of the complex number unchanged and changes only the phase of the complex number.

For ease of description, the above descriptions are provided under the assumption that two SAR images are received and processed, and one topographic fringe is outputted. Practically, three or more SAR images are used, and two or more sets of SAR images are specified at the correlation-determination processor 1052 to output multiple topographic fringes 1060 according to the number of the sets of the SAR images.

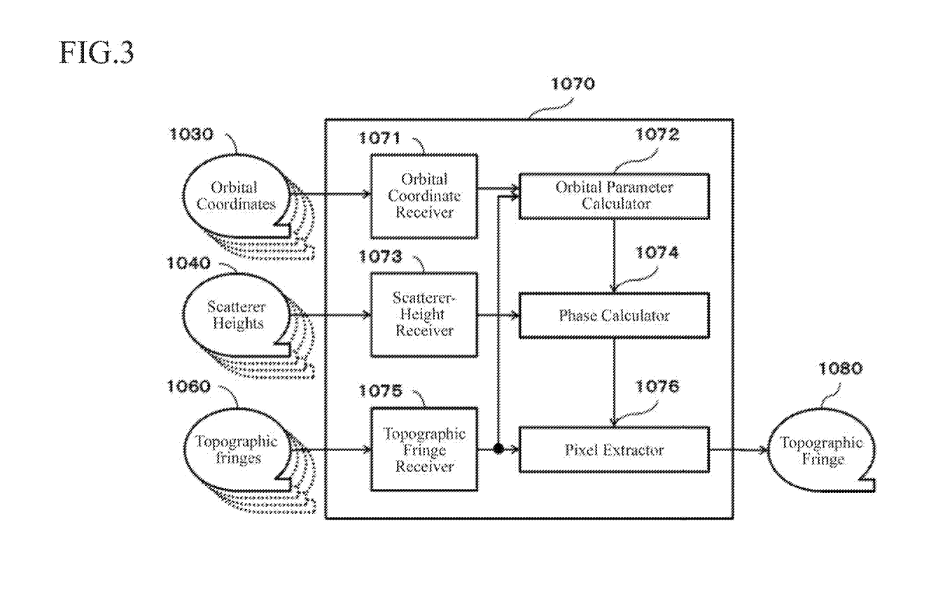

FIG. 3 is a functional block diagram illustrating the functions of the extraction processor 1070. With reference to FIG. 3, the functions of the extraction processor 1070 will now be described. The extraction processor 1070 includes an orbital coordinate receiver 1071, an orbital parameter calculator 1072, a scatterer-height receiver 1073, a phase calculator 1074, a topographic fringe receiver 1075, and a pixel extractor 1076.

The orbital coordinate receiver 1071 receives the orbital coordinates 1030 that is the data of the orbital position (latitude, longitude, or map coordinates and height) of the sensor that has captured each SAR image. In detail, the orbital coordinate receiver receives the orbital position information on the sensor that has captured each set of SAR images generating each topographic fringe received at the topographic fringe receiver 1075. The orbital parameter calculator 1072 calculates the height of the scatterer and the coefficient of the phase (orbital parameter) using the topographic fringes 1060 received at the topographic fringe receiver 1075 and the orbital position information on the sensor that has captured the two SAR images forming the topographic fringes 1060, among the entire orbital position information on the sensor received at the orbital coordinate receiver 1071. The orbital parameter calculator 1072 receives the topographic fringes 1060 and the orbital positions of the sensor, and outputs the orbital parameter of each topographic fringe.

The scatterer-height receiver 1073 receives the scatterer heights 1040, i.e., the user-specified heights of scatterers to be extracted. In the case where the height of the scatterer to be extracted is known, this height is defined as the scatterer height 1040 and the extraction processor 1070 extracts the signals of the scatterer at this height. In the case where the height of the scatterer to be extracted is unknown, multiple heights as the scatterer heights 1040 are specified and the extraction processor 1070 repeats the extraction process at the specified heights to extract the signals of the scatterers at each specified height. The extraction processor 1070 outputs the extracted images 1080 according to the number of heights specified by the user. For ease of description, in the description of the extraction processor 1070, it is assumed that the scatterer heights 1040 are specified as one combination.

The phase calculator 1074 calculates the phase of the topographic fringe of the scatterer to be extracted for each set of SAR images that generate each topographic fringe using the orbital parameter calculated at the orbital parameter calculator 1072 and the scatterer heights 1040 received at the scatterer-height receiver 1073. The phase calculator receives the height of the scatterer and the orbital parameter, and outputs the phase of the topographic fringe of the scatterer to be extracted.

The topographic fringe receiver 1075 receives multiple topographic fringes 1060 outputted from the interference phase processor 1050. The pixel extractor 1076 extracts the pixels of the scatterers at the specified height using the topographic fringe received at the topographic fringe receiver 1075 and the phase of the topographic fringe of the scatterer to be extracted that is calculated at the phase calculator 1074. The pixel extractor extracts the pixels having the phases close to the phase received from the phase calculator 1074 for each topographic fringe received at the topographic fringe receiver 1075. The pixel extractor repeats the same process for each topographic fringe, and the pixels are extracted using all the topographic fringes to generate the extracted images of the scatterers at the specified height. The pixel extractor receives the topographic fringe and the phase of the topographic fringe of the scatterer to be extracted, and outputs the extracted images 1080.

For ease of description, in the above descriptions, the scatterer heights 1040 are specified as one combination, and the extracted images 1080 of scatterers at specified heights as one type of images are outputted. Practically, multiple extracted images 1080 are outputted according to the number of the heights specified as the scatterer heights 1040.

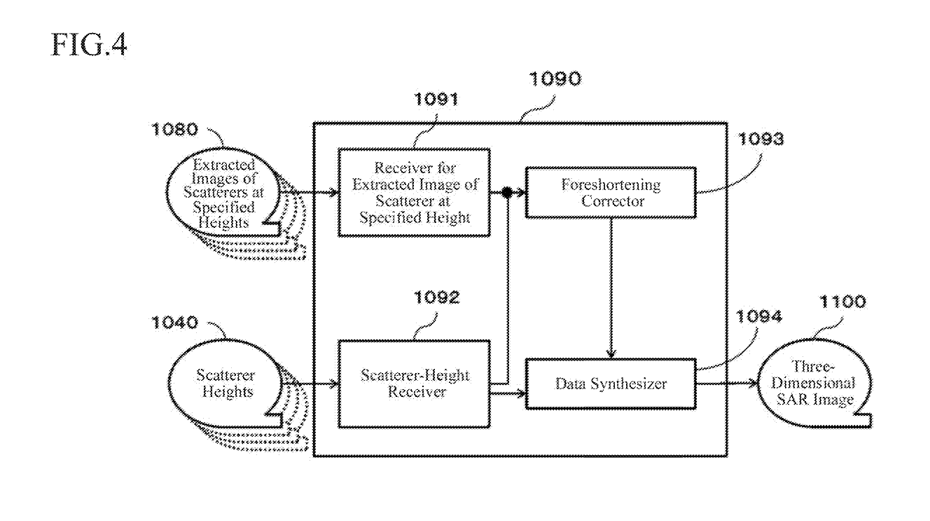

FIG. 4 is a functional block diagram illustrating the functions of the signal synthesizer 1090. With reference to FIG. 4, the functions of the signal synthesizer 1090 will now be described. The signal synthesizer 1090 includes a receiver 1091 of an extracted image of a scatterer at a specified height (hereinafter an “extracted image receiver 1091”), a scatterer-height receiver 1092, a foreshortening corrector 1093, and a data synthesizer 1094.

The extracted image receiver 1091 receives the extracted images 1080 output ted from the extraction processor 1070. The scatterer-height receiver 1092 receives the scatterer heights 1040. The scatterer heights 1040 correspond to the extracted images 1080 received at the extracted image receiver 1091. The foreshortening corrector 1033 corrects the distortion of the SAR image caused by foreshortening for each extracted image 1080 at the corresponding scatterer heights 1040 using multiple extracted images 1080 received at the extracted image receiver 1031 and the scatterer heights 1040 received at the scatterer-height receiver 1092. The foreshortening corrector receives the scatterer heights 1040 and the extracted images of the scatterers at the specified heights, and outputs the extracted images of the scatterers after the correction for the foreshortening.

The data synthesizer 1094 overlays the extracted images of the scatterers after the correction for the foreshortening at the scatterer heights 1040 to generate a three-dimensional SAR image 1100 using the extracted images of the scatterers after the correction for the foreshortening corrected at the foreshortening corrector 1093 and the scatterer heights 1040 received at the scatterer-height receiver 1092. The data synthesizer receives the heights of the scatterers and the extracted images of the scatterers after the correction for the foreshortening, and outputs the three-dimensional SAR image 1100.

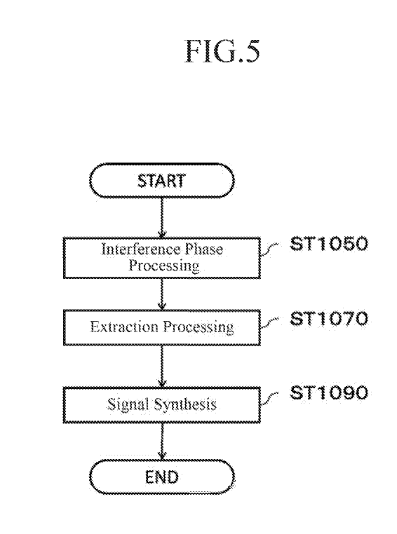

FIG. 5 is a flow chart illustrating the operations of the 3D image generating unit 1000 for the SAR image in accordance with the first embodiment. With reference to FIG. 5, the operations of the 3D image generating unit 1000 for the SAR image will now be described in accordance with the first embodiment.

As described in FIG. 5, the 3D image generating unit 1000 for the SAR image in accordance with the first embodiment has three major steps. In Step ST1050 (interference phase processing), the interference phase processor 1050 generates the topographic fringes 1060 using the SAR image 1011, the SAR image 1012, the GCP data 1020, and the orbital coordinates 1030. In Step ST1070 (extraction processing), the extraction processor 1070 outputs the extracted images 1080 using the topographic fringes 1060, the orbital coordinates 1030, and the scatterer heights 1040. In Step ST1090 (signal synthesis), the signal synthesizer 1090 outputs the three-dimensional SAR image 1100 using the extracted images 1080.

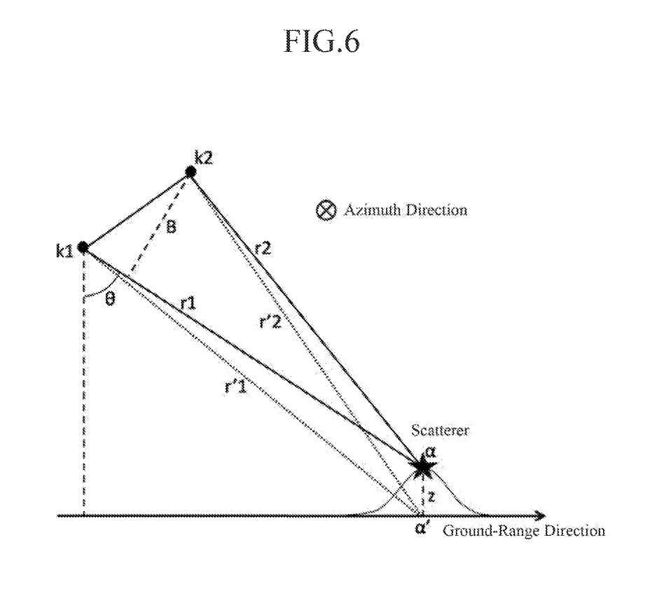

FIG. 6 is a conceptual diagram illustrating the concept of an interference phase in the SAR in accordance with the first embodiment. With reference to FIG. 6, the outline of Step ST1050 (interference phase processing) will now be described. An object of Step ST1050 is to generate a topographic fringe from two SAR images. The interference phase, the orbital fringe, and the topographic fringe for each pixel in the SAR image are described below. In FIG. 6, a platform is assumed to be moving from the front to the back of the drawing plane, indicating that the azimuth direction is directed from the front to the back of the drawing place. The direction of the arrow is the ground-range direction corresponding to the direction of the radio wave radiation.

The reflected signals from a scatterer α in the SAR image are discussed under the assumption that a SAR sensor platform (e.g. artificial satellite) has captured two SAR images at the orbital positions k1 and k2 respectively. The orbital position k2 has the different position from the orbital position k1. In theory, the phase difference φs (interference phase) of the reflected signals from the scatterer α between the two SAR images is defined by Expression (4):

φs=W{(2·p·π·(r1−r2))/λ} (4)

where r1; the distance between the platform k1 and the scatterer α, and r2; the distance between the platform k2 and the scatterer α. As described in Expression (4), the difference in phase φs (interference phase) of the reflected signals is in proportion to the difference in distance r1−r2, i.e., the difference between the distance from the platform k1 to the scatterer α and the distance from the platform k2 to the scatterer α. It is noted that the phase has a value wrapped by 2π.

The phase difference φg (called orbital fringe) of the reflected signals from the scatterer between the two SAR images is similarly defined under the assumption that a virtual scatterer is present at a position α′ on the ground surface corresponding to the position a of the scatterer. This orbital fringe φg is defined by Expression (5):

φg=W{(2·p·π·(r′1−r′2))/λ} (5)
where r′1; the distance between the platform k1 and the scatterer α′, and
r′2: the distance between the platform k2 and the scatterer α′, The distance r′1 and r′2 can be calculated using the known positional information on the orbital coordinates and the known cartographic information on all the SAR images, allowing Express (5) to calculate the value of the orbital fringe φg.

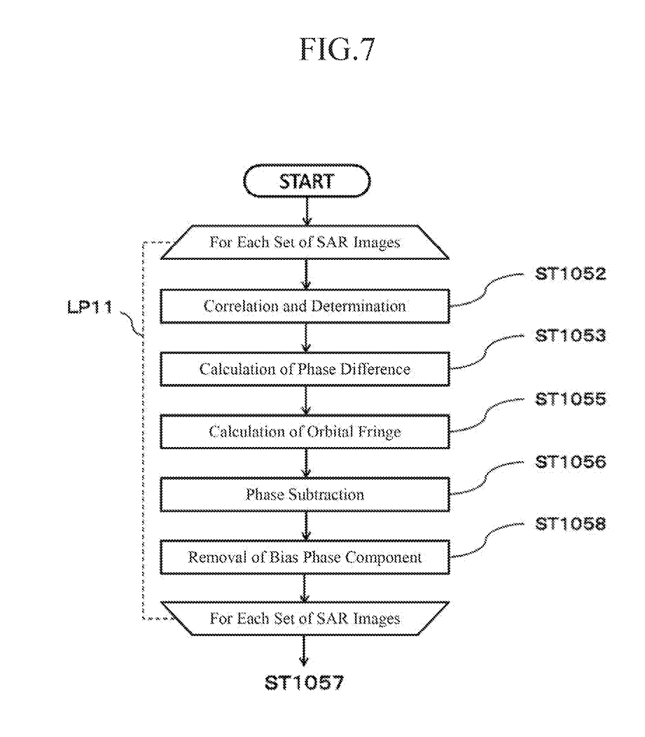

FIG. 7 is a flow chart illustrating the process of Step ST1050 (interference phase processing). With reference to FIG. 7, the process of Step ST1050 will now be described in detail. As described in FIG. 7, step ST1050 includes a loop process of Loop LP11. Loop LP11 repeats the loop process for each set of the SAR images. In the following description, the received SAR images 1010 include three or more BAR images, thus providing multiple combinations of SAR images. Loop Lp11 repeats the loop process according to the number of the combinations of SAR images. In Step ST1052 (correlation and determination), the SAR image receiver 1051 receives multiple SAR images of the identical location captured by a synthetic aperture radar at different orbital positions. The correlation-determination processor 1052 correlates the received two SAR images to determine whether each pixel has signal overlapping. If the signal of a pixel is a reflected signal from a scatterer, the pixel of one of the SAR images is correlated with the corresponding pixel of the other SAR image. If the signal of the pixel includes multiple signal components due to some reasons, such as layover, the pixels have no correlation between SAR images. The correlation determination process determines whether each pixel has a single signal component or two or more signal components, and outputs the coordinates of the pixel of interest having a single signal component for the following processes.

In Step ST1053 (calculation of phase difference), the phase difference calculator 1053 calculates the phase difference φs between the pixel of interest of one of the two SAR images and the corresponding pixel of the other SAR image, where the pixels of interest axe determined in Step ST1052 (correlation and determination), and calculates the interference phase φs of each pixel and the signal amplitude of the pixel. For example, in the case where the signal information received from the SAR image receiver 1051 includes the data of complex numbers, the phase difference calculator outputs the product of the complex number of the signal of a pixel in one SAR image and the conjugate complex number of the signal of the corresponding pixel in the other SAR image. The complex number of the product has an absolute value representing the product of the signal amplitude in the SAR images and an argument representing the interference phase φs.

In Step ST1055 (calculation of orbital fringe), the orbital coordinate receiver 1054 receives the orbital position information (latitude, longitude, or map coordinates and height) of the sensor that has captured the received two SAR images. The orbital fringe calculator 1055 calculates the phase of the orbital fringe φg for each pixel by Expression (5) using the cartographic information (latitude, longitude, or map coordinate) of each pixel in the received two SAR images, the orbital position information on the sensor that has captured the two SAR images received at the orbital coordinate receiver 1054 and the satellite information (wavelength λ of radiated radio wave), and generates the orbital fringe φg of each pixel.

In Step ST1056 (phase subtraction), the phase subtractor 1056 receives the interference phase of each pixel (the phase φs and the signal amplitude of the pixel) calculated in Step ST1053 (calculation of phase difference) and the orbital fringe φg calculated in Step ST1055 (calculation of orbital fringe). The phase subtractor 1056 calculates the difference in phase (φs−φg) defined as φc. The phase subtractor calculates the corrected interference phase of each pixel (the phase φc and the signal amplitude of the pixel) using the value φc and the signal amplitude of the interference phase. The corrected interference phase holds the data of the signal amplitude outputted from the phase difference calculator 1053 without any change. For example, in the case where the phase difference calculator 1053 calculates the product of a complex number and a conjugate complex number, Step ST1056 holds the absolute value of the complex number unchanged, shifts the argument from φs to φs−φg, and outputs the resulting complex number.

In Step ST1058 (removal of bias phase), the GCP receiver 1057 receives the GCP (the coordinates of the three pixels of known scatterers at the same height in the SAR image). The bias removing unit 1058 generates a phase plane φb including the phases φc of the GCP coordinates at the GCP coordinates of the three pixels of all the pixels in the SAR image using the corrected interference phase of each pixel (the phase φc and the signal amplitude of the pixel). The bias removing unit subtracts the phase plane φb from the phase φc, or calculates the phase φz for all the pixels such that the GCP coordinates have the same phase, and outputs the topographic fringe 1060 of each pixel (the phase φz and the signal amplitude of the pixel). In theory, the phase φz of the topographic fringe is defined as Expression (6):

φz=W{(2·π·p·B/λ·R·sin θ)·z} (6)

where the phase φz of the topographic fringe is in proportion to the height z of the scatterer. It is noted that the phase has a value wrapped by 2π. Any scatterers at the same height z have the same value of the phase φz of the corrected topographic fringe.

It is noted that Step ST1058, like Step ST1056, outputs the data that holds the signal amplitude data outputted from the phase difference calculator 1053 without any change. For example, in the case where the phase difference calculator 1053 calculates the product of a complex number and a conjugate complex number. Step ST1058 holds the absolute value of the complex number unchanged, shifts the argument from the value φc to the value φc−φb and outputs the resulting complex number. Step ST1050 (interference phase processing) outputs the phase of the topographic fringe and the signal amplitude of each pixel in the image for each set of the SAR images. That is all of the descriptions of the process of Step ST1050 (interference phase processing).

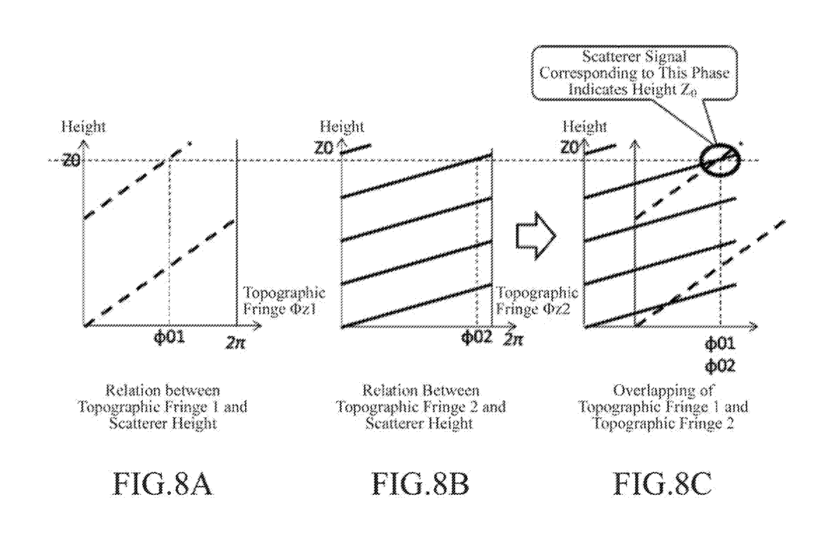

The outline of Step ST1070 (extraction processing) will now be described. For ease of description, the process is described for a specific phase φz1 in one topographic fringe and a specific phase φz2 in another topographic fringe. FIGS. 8A to 8C illustrate the relations between the topographic fringe and the height in two sets of SAR images. As described in Expression (6), the phase φz of the topographic fringe is in proportion to the height z of the scatterer. In the traditional techniques, as described in Expression (7), the height z0 has been estimated using the phase φz0 of the topographic fringe of the scatterer in the observed SAR image. However, since the phase φz0 of the topographic fringe is wrapped by 2π, it has multiple solutions of the height z0 (height ambiguity).

φz0=W{(2·πp·B/λ·R·sin θ)·z0} (7)

In contrast, in the first embodiment, the topographic fringe φz0 corresponding to the height is calculated after the height z0 is specified, and the scatterers are extracted that have the phase φz of the topographic fringe equal to the phase φz0 in the SAR image. In the case where the height of the scatterer to be extracted is known, this height is defined as the height z0 and the signals of the scatterers at the specified height z0 are extracted in the following process. In the case where the height of the scatterer to be extracted is unknown, multiple heights z0 are specified and the signals of the scatterers at each specified height z0 are extracted at the specified heights z0 in the following process.

With reference to FIGS. 8A, 8B and 8C, the extraction of the scatterers at the specified heights is described that is performed using a set of SAR images having the baseline B1 and another set of SAR images having the baseline B2.

FIG. 8A illustrates the relation between the topographic fringe φz1 and the height in the set of two SAR images having the baseline B1. This relation is represented by Expression (6). In the case where the set of SAR images having the baseline B1 is used, the phase of the topographic fringe φz1 corresponding to the height z0 is calculated by Expression (7), and defined as φ01.

FIG. 8B illustrates the relation between the topographic fringe φz2 and the height in the set of two SAR images having the baseline B2 that is different front the baseline B1. This relation meets the relation between the phase of the topographic fringe and the height of the scatterer in Expression (6). Since the length is different between the baseline B1 and the baseline B2, it can be seen that the wrapping cycle is different between FIGS. 8A and 8B. In the case where the set of SAR images having the baseline B2 is used, the phase of the topographic fringe φz2 corresponding to the height z0 is calculated by Expression (7), and defined as φ02.

FIG. 8C is the overlapping of FIGS. 8A and 8B where the topographic fringe φ01 and the topographic fringe φ02 are aligned at the same position in the horizontal axis of the topographic fringe. It can be seen that only the height z0 has the phase φ01 in the topographic fringe φz1 of the baseline B1 and the phase φ02 in the topographic fringe φz2 of the baseline B2. The pixels are then extracted from all the pixels that have the phase φ01 in the corrected topographic fringe φz1 and the phase φ02 in the corrected topographic fringe φz2.

In the case where the data of the topographic fringe includes erroneous data due to some reasons such as signal noise, the range of the specified phase to be extracted is expanded to cover the erroneous data. For example, the specified phases to be extracted from all the pixels range from φ01−Δφ1 to φ01+Δφ1 for the topographic fringe φz1 and from φ02−Δφ2 to φ02+Δφ2 for the topographic fringe φz2. The values of Δφ1 and Δφ2 can be, for example, the deviations in the distribution of the phase of each topographic fringe.

Step ST1070 (extraction processing) similarly repeats the above process for the topographic fringes of other sets of the SAR images having the different baselines B.

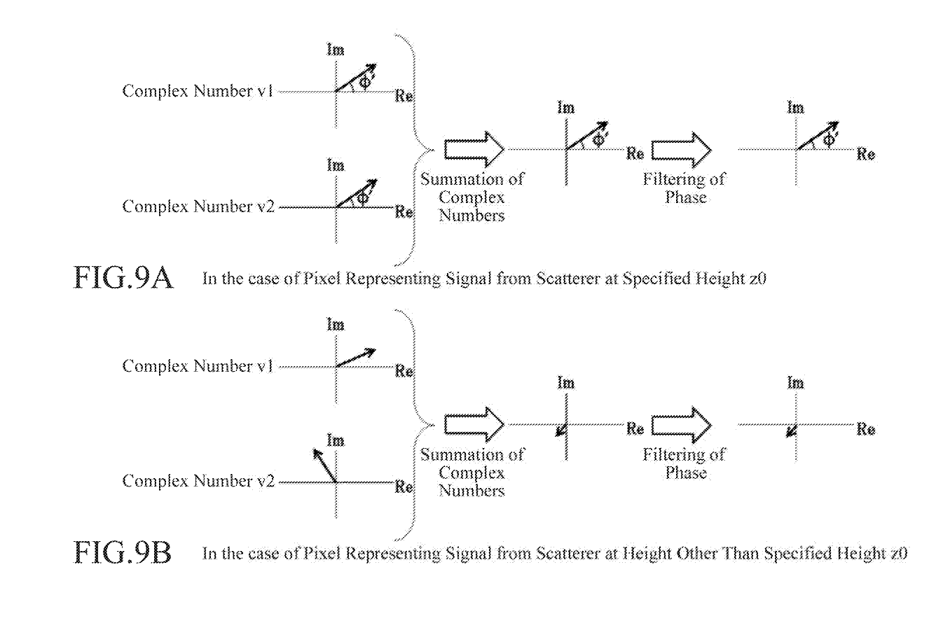

FIGS. 9A and 9B illustrate exemplary signals in each pixel in a complex plane when the topographic fringe is processed as a complex number. With reference to FIGS. 9A and 9B, one exemplary method of achieving Step ST1070 will now be described. For ease of description, the process of two different topographic fringes is discussed.

The topographic fringe 1060 outputted at Step ST1050 (interference phase processing) includes the information on the signal amplitude and the phase of each pixel in the SAR image. The topographic fringe of each pixel is defined as a complex number v that has an absolute value representing the signal amplitude and an argument representing the phase φz.

In the case where a set of SAR images having the baseline B1 is used, the specific phase φz1 of the topographic fringe is calculated by Expression (7) that corresponds to the height z0, and defined as φ01. The topographic fringe of the set of SAR images having the baseline B1 has the complex number v1, The argument of the topographic fringe v1 is shifted by φ01−φ′ for all the pixels such that the pixels having the argument φ01 have a fixed argument φ′.

In the case where a set of SAR images having the baseline B2 is used, the specific phase φz2 of the topographic fringe is calculated by Expression (7) that corresponds to the height z0, and defined as φ02. The topographic fringe of the set of SAR images having the baseline B2 has the complex number v2, The argument of the topographic fringe v2 is shifted by φ02-φ′ for all the pixels such that the pixels having the argument φ02 have a fixed argument φ′.

After the shift process of the argument, the complex numbers of the pixels have the argument φ′ as described in PIG. 9A that represents the reflected signals from scatterers at the specified height z0 in the SAR image, in the topographic fringe of each baseline. The complex numbers of the pixels do not have the argument φ′ as described in FIG. 9B that represents the reflected signals from scatterers at the heights other than the height z0 in the SAR image, and the same pixels have different arguments depending on the topographic fringe, in the topographic fringe of each baseline.

The sum of the complex numbers of multiple topographic fringes is then calculated for each pixel. The sum may further be divided by the number of the topographic fringes to calculate the average. As described in FIG. 9A, all the complex numbers of the pixels that represents the reflected signals from scatterers at the specified height z0 in the SAR image have the same argument φ′ in multiple topographic fringes for each pixel. The calculation of the average causes the complex number to represent almost the same signal as the original signal before the summation, and the argument is close to φ′. As described in FIG. 9B, the complex numbers of the pixels that represents the reflected signals from scatterers at the heights other than the height z0 in the SAR image have the different arguments in multiple topographic fringes for each pixel. The calculation of the sum causes the complex numbers to counteract each other, and thus the amplitude becomes smaller than that of the original signal and the argument is not necessarily close to φ′.

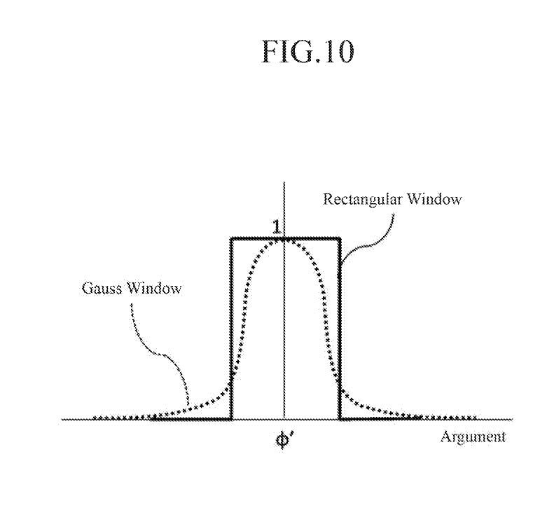

Lastly, the filtering of the phase is performed to extract the signals having the argument φ′. FIG. 10 is an example of the filter to extract the signals having the argument φ′. As described in FIG. 10, examples of the filter shape include the shapes such as the rectangular window and the gauss window. As described in FIG. 9A, the signal from the scatterer at the height z0 in the SAR image is retained after the filtering because the argument of the signal is close to the argument φ′. As described in FIG. 9B, the signal from the scatterer at the heights other than the height z0 in the SAR image is removed by the filtering because the argument of the signal is not close to the argument φ′. Therefore, only the scatterers at the specified height z0 are extracted.

For ease of description, the above processes are performed using two sets of the topographic fringes. The same processes are performed for the topographic fringes of other sets of the SAR images for other different baseline B.

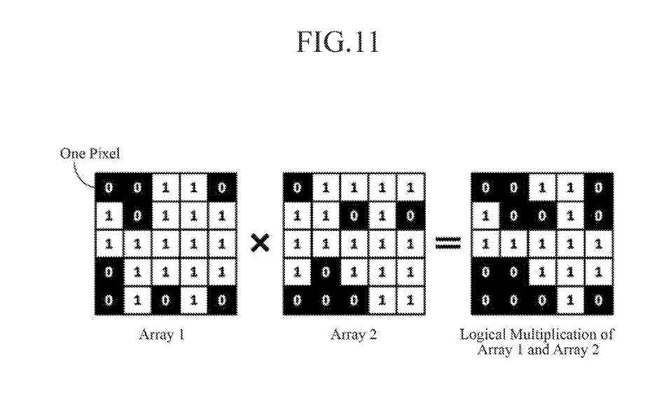

FIG. 11 illustrates exemplary arrays corresponding to the pixels of each topographic fringe. With reference to FIG. 11, one different exemplary method of achieving Step ST1070 will now be described. The method generates the arrays corresponding to the number of the pixels of each topographic fringe, and calculates the logical multiplication of each element between the arrays.

The topographic fringe 1060 includes the signal phase information of each pixel in the SAR image. Only the information of the phase φz of each pixel is used. For ease of description, the process of two topographic fringes is discussed. As described in FIG. 11, two arrays (array 1 and array 2) are generated, each having the same number of the pixels as the SAR image for each topographic fringe.

In the case where a set of the SAR images having the baseline B1 is used, the specific phase φz1 of the topographic fringe that corresponds to the height z0 is calculated for each pixel of the images by Expression (7). The elements of the array corresponding to the pixels of the SAR image that have the phase φ01 (in the case where the phase has erroneous data, the pixels of the SAR image that have the phase ranging from φ01−Δφ1 to φ01+Δφ1) have a value “1”, and the elements of the array corresponding to the pixels of the SAR image that do not have the phase ranging from φ01 −Δφ1 to φ01 +Δφ1 have a value “0” (array 1). Similarly, in the case where a set of the SAR images having the baseline B2 is used, the specific phase φz2 of the topographic fringe that corresponds to the height z0 is calculated for each pixel of the images fay Expression (7). The elements of the array corresponding to the pixels of the SAR image that have the phase φ02 (in the case where the phase has erroneous data, the pixels of the SAR image that have the phase ranging from φ02−Δφ2 to φ02+Δφ2) have a value “1”, and the elements of the array corresponding to the pixels of the SAR image that do not have the phase ranging from φ02−Δφ2 to φ02+Δφ2 have a value “0” (array 2).

Array 1 is further multiplied by Array 2 for each element (logical multiplication). The resulting value 1 of the element indicates that the phase φz1 has a value “φ01” (in the case where the phase has erroneous data, for example, a value ranging from φ01−Δφ1 to φ01+Δφ1) and the phase φz2 has a value “φ02” (in the case where the phase has erroneous data, for example, a value ranging from φ02−Δφ2 to φ02+Δφ2). The amplitude of the topographic fringe of the pixel can be extracted as a signal from the scatterer at a height z0 where the corresponding element in the array has a value “1”. For ease of description, the above processes are performed using two sets of topographic fringes. The same processes are performed for the topographic fringe of any other set of SAR images having different baselines B.

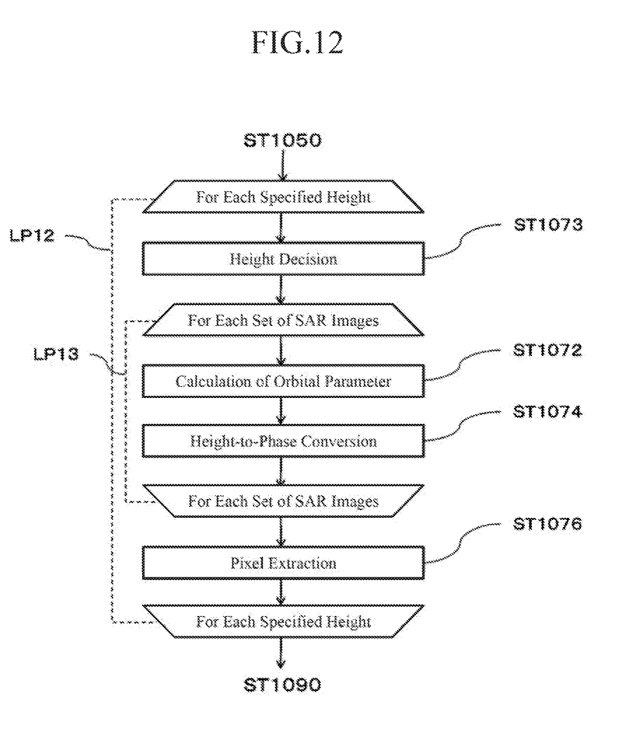

FIG. 12 is a flow chart illustrating the process of Step ST1070 (extraction processing). With reference to FIG. 12, the process of Step ST1070 (extraction processing) will now be described in detail. As described in FIG. 12, Step ST1070 includes two loop processes, i.e., Loop Lp12 and Loop LP13. Loop LP12 repeats the process for each height specified in Step ST1073, or Loop LP12 repeats the process at the heights specified in Step ST1073. Loop LP13 repeats the process for each set of SAR images that generate an interference wave, or Loop LP13 repeats the process according to the number of the sets of SAR images.

In Step ST1073 (height decision), the scatterer-height receiver 1073 receives the user-specified heights z0 of scatterers to be extracted. In the case where the height of the scatterer to be extracted is known, this height is defined as a height z0 and the process of Loop LP12 is performed. In the case where the height of the scatterer to be extracted is unknown, multiple heights z0 are specified and the process of Loop LP12 is repeated for each specified height to extract the signals of the scatterers at each height z0.

In Step ST1072 (orbital parameter calculation), the orbital coordinate receiver 1071 receives the orbital position information (latitude, longitude, or map coordinates and height) of the sensor that has captured the two SAR images generating the topographic fringe received at the topographic fringe receiver 1075. The orbital parameter calculator 1072 calculates the distance R from the center between the orbital positions of two sensors to the center of the image, the off-nadir angle θ and the parameter of the baseline B using the received orbital position information on the sensor, and calculates each orbital parameter m by Expression (8):

m=2·π·p·B/λ·R·sin θ (8)

In Step ST1074 (height-to-phase conversion), the phase calculator 1074 determines the phase φz0 of the topographic fringe of the scatterer to be extracted for each set of SAR images using the orbital parameter m outputted at Step ST1072 and the extraction height z0 specified in Step ST1073, and outputs the phase φz0. The phase φz0 is calculated by Expression (9):

φz0=W{m·z0} (9)

In Step ST1076 (pixel extraction), the topographic fringe receiver 1075 receives multiple topographic fringes 1060 outputted at Step ST1050. The pixel extractor 1076 extracts the scatterers at the specified heights using the data received at the phase calculator 1074 and the topographic fringe receiver 1075. The pixel extractor extracts the pixels having the phases close to the phase φz0 received from the phase calculator 1074 according to the above methods described in FIGS. 8, 9, 10 and 11 for each data set of multiple topographic fringes received from the topographic fringe receiver 1075. The pixel extractor repeats the same process for all the topographic fringes, defines the pixels extracted from all the topographic fringes as the scatterers at the specified heights z0, and outputs the extracted images 1080.

Step ST1070 (extraction processing) outputs the images that have extracted only the scatterers at the specified heights in the SAR image at the user-specified heights. That is all of the descriptions of the process of Step ST1070 (extraction processing).

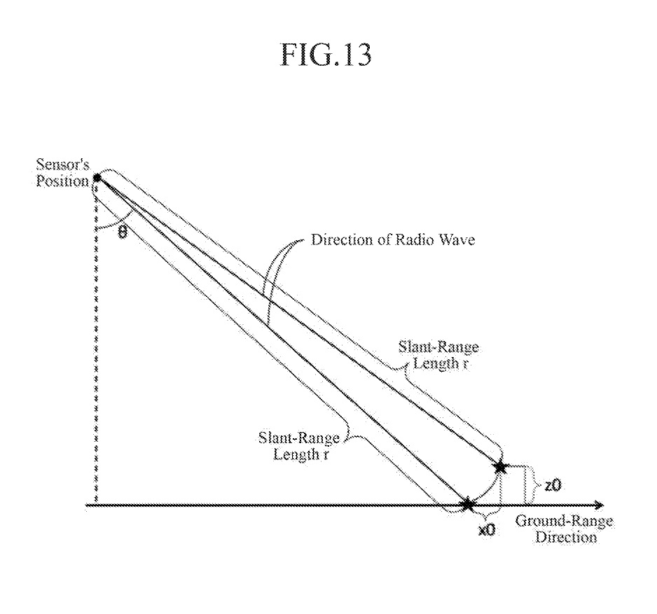

FIG. 13 is a conceptual diagram illustrating the concept of the foreshortening in the SAR image in accordance with the first embodiment. With reference to FIG. 13, the positional displacement of the scatterer caused by the foreshortening and the correction for the displacement will now be described. A platform is assumed to be moving from the front to the back of the drawing plane, indicating that the azimuth direction is directed from the front to the back of the drawing place. The direction of the arrow in the horizontal axis is the ground-range direction corresponding to the direction of the radio wave radiation.

As described in FIG. 13, in the case where a radio wave is radiated at the off-nadir angle θ, the height of the scatterer is defined as z0 and the length between the scatterer and the sensor (slant-range length) is defined as r. In the SAR image, the scatterer is determined to be present at the position on the ground that have the same slant-range length r, and displayed at the position having a displacement x0 toward the sensor on the ground in the SAR image. The displacement x0 is defined by Expression (10):

x0=z0/tan θ (10)

In the case where the SAR image is displayed in three dimensions, the position is corrected to the original position according to the height z0 of the scatterer, where the position having the displacement x0 toward the sensor is shifted by the same distance as the displacement x0 toward the opposite side of the sensor on the ground range.

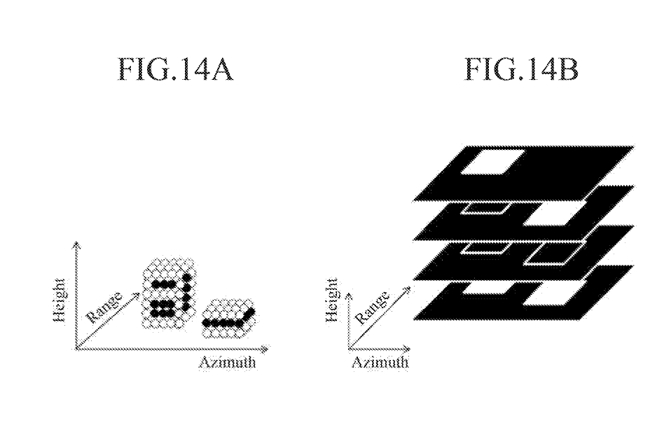

Examples of the methods for displaying 3D SAR images include methods as described in FIGS. 14A and 14B. FIGS. 14A and 14B illustrate exemplary 3D SAR images. For example, FIG. 14A illustrates a method for plotting an image on three-dimensional axes consisting of the range, azimuth, and height. For example, FIG. 14B illustrates a method for overlapping SAR images at the heights corresponding to the heights z0, as if the sliced structure of a single SAR image is displayed.

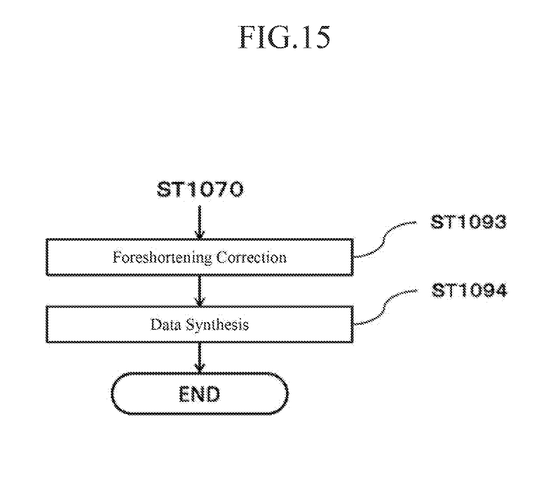

FIG. 15 is a flow chart illustrating the process of Step ST1090 (signal synthesis). With reference to FIG. 15, the process of Step ST1090 (signal synthesis) will now be described in detail. In Step ST1093 (foreshortening correction), the extracted image receiver 1091 receives the extracted images 1080 outputted from the extraction processor 1070. The scatterer-height receiver 1092 receives the scatterer heights 1040 as the heights z0 that correspond to the extracted images 1080. The foreshortening corrector 1093 calculates the positional displacement x0 of the scatterer caused by the foreshortening toward the sensor on the ground range in the SAR image by Expression (10) to correct the scatterer position. The position is shifted by the same distance as the displacement x0 toward the opposite side of the sensor on the ground range in the SAR image. This process is performed for the extracted images of the scatterers at the specified heights received at the extracted image receiver 1091 for each of the heights z0.

In Step ST1054 (data synthesis), the data synthesizer 1094 synthesizes the data of the extracted images of the scatterers at the specified heights that are corrected in Step ST1093 to output a three-dimensional SAR image 1100. For example, the data synthesizer overlaps the data at the heights corresponding to the heights z0. Step ST1090 (signal synthesis) receives the extracted images of the scatterers at the user-specified heights and the heights z0 corresponding to the extracted images, overlaps all the images at the specified heights and outputs the three-dimensional data of the SAR image. That is all of the descriptions of the process of Step ST1090 (signal synthesis).

The traditional techniques estimate the heights of scatterers from the phase of the observed topographic fringe, but cannot estimate the heights of scatterers higher than the height zmax of Expression (2) that corresponds to the shortest baseline length. In contrast, the first embodiment extracts the scatterers at the heights corresponding to the specified phases. The first embodiment further uses the sets of SAR images having multiple baselines, specifies multiple phases corresponding to the heights to be extracted for each set of SAR images, and extracts the pixels having the specified phases for all the sets of SAR images. By specifying multiple phases corresponding to the sets of SAR images and extracting the pixels having the specified phases for ail the sets of SAR images, the scatterers can be discriminated from each other up to a height larger than that of the traditional techniques.

The first embodiment uses multiple baselines. One of the baselines is called the first baseline length and the other baseline is called the second baseline length. In multiple topographic fringes 1060, the topographic fringe corresponding to the first baseline length is called the first topographic fringe and the topographic fringe corresponding to the second baseline length is called the second topographic fringe.

The synthetic-aperture radar signal processing apparatus 1 in accordance with the first embodiment includes an interference phase processor 1050 that calculates a first topographic fringe represented by multiple pixels, representing a relative phase between signals contained in two pixels representing the same scatterer in a first set of two synthetic aperture radar images using the first set of two synthetic aperture radar images generated by two sensors having a first baseline length; and a second topographic fringe represented by multiple pixels, representing a relative phase between signals contained in two pixels representing the same scatterer in a second set of two synthetic aperture radar images using the second set of two synthetic aperture radar images generated by two sensors having a second baseline length; and an extraction processor 1070 including a phase calculator 1074 calculating a first specific phase that corresponds to a scatterer at at least one specific height in the first topographic fringe and a second specific phase that corresponds to the scatterer at the at least one specific height in the second topographic fringe; and a pixel extractor 1076 extracting a pixel corresponding to the at least one specific height from the first topographic fringe and the second topographic fringe, the pixel having the first specific phase in the first topographic fringe and the second specific phase in the second topographic fringe, the first and second topographic fringe being calculated at the interference phase processor 1050.

The synthetic-aperture radar signal processing apparatus 1 in accordance with the first embodiment is characterized in that the at least one specific height are higher than a specific height measurable with only two sensors that have a shorter one of the first baseline length and the second baseline length. The specification of the specific heights allows the synthetic-aperture radar signal processing apparatus 1 in accordance with the first embodiment to estimate the heights of scatterers at positions higher than those of the traditional techniques.

The synthetic-aperture radar signal processing apparatus 1 in accordance with the first embodiment is characterized in that the interference phase processor 1050 specifies three or more GCP pixels representing the scatterers at the same known heights in the first set of two synthetic aperture radar images or the second set of two synthetic aperture radar images, and a bias removing unit corrects the phases of the pixels in the two synthetic aperture radar images such that the phases of the signals included in the three or more pixels have the same value in the two synthetic aperture radar images. This configuration can have the consistency of the observation phase between one of the sensors having the first baseline length and the other sensor having the second baseline length when the two sensors have observed the identical scatterer, thus removing the phase bias between the two sensors.

The synthetic-aperture radar signal processing apparatus 1 in accordance with the first embodiment is characterized in that the extraction processor 1070 has the orbital parameter calculator that calculates the orbital parameter corresponding to the first baseline length and the orbital parameter corresponding to the second baseline length using the orbital information on the two sensors that have the first baseline length, and the second baseline length, and the phase calculator calculates the first specific phase and the second specific phase using the orbital parameters calculated at the orbital parameter calculator. The use of the orbital information on the sensor can remove the observation phase components caused by some reasons such as sensor motion and calculate the specific phase corresponding to the topographic fringe.

The synthetic-aperture radar signal processing apparatus 1 in accordance with the first embodiment is characterized in that the apparatus determines whether the two pixels include a single reflected signal or multiple reflected signals based on the temporal or spatial variation in the phase difference between the two pixels representing the identical scatterer, i.e., the pixels in the first set of two synthetic aperture radar images or the pixels in the second set of two synthetic aperture radar images. This configuration can extract the pixels without multiple reflected signals from the SAR image.

The synthetic-aperture radar signal processing apparatus 1 in accordance with the first embodiment is characterized in that the at least one specific height includes a plurality of specific heights in the extraction processor 1070, the pixel extractor 1076 extracts the pixels corresponding to the specific heights, and the signal synthesizer generates a three-dimensional image using the pixels at the specific heights extracted at the extraction processor 1070. This configuration can generate a three-dimensional image using SAR images extracted at the different heights.

### Second Embodiment

In the first embodiment, the distances r′1 and r′2 between a sensor and a scatterer, the distance R, the baseline length B, and the off-nadir angle θ are calculated using the orbital position information on the sensor to generate an orbital fringe φg and an orbital parameter m. Since the accuracy of the parameters r′1, r′2, R, and B significantly depends on the accuracy of the orbital position information on the sensor, the accuracy of the orbital position information on the sensor is required. The second embodiment provides a method of calculating an orbital fringe and an orbital parameter m with high accuracy using the off-nadir angle θ of the radiated radio wave from the sensor that has captured SAR image instead of r′1, r′2, R, and B, even if the accuracy of the orbital position information on the sensor is not enough. In the following descriptions, the same reference numerals used in the first embodiment are assigned to the same input data, output data, units and steps without redundant description.

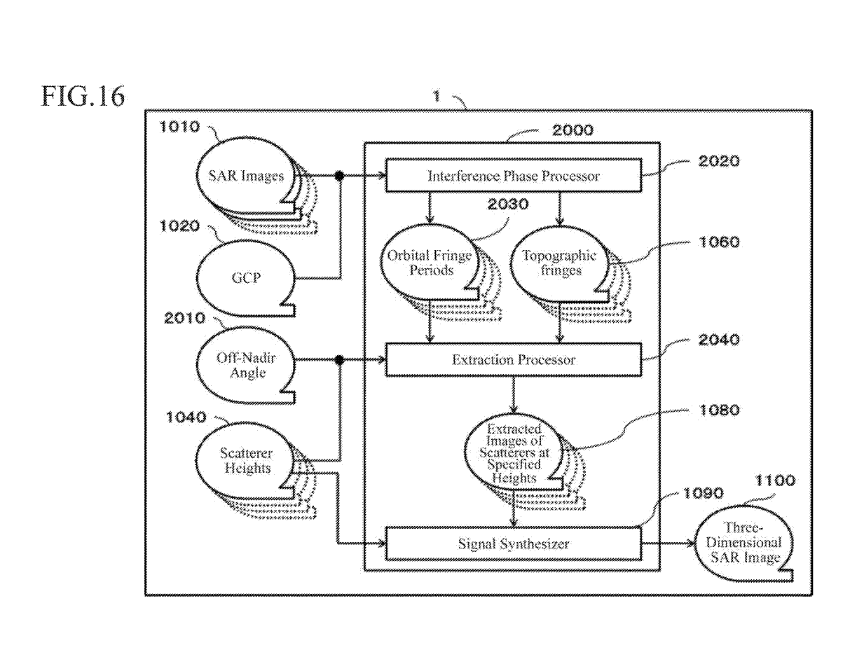

FIG. 16 is an overall configuration diagram of a device that estimates the height of the scatterer in the SAR image in the synthetic-aperture radar signal processing apparatus 1 in accordance with the second embodiment. With reference to FIG. 16, the outline of a 3D image generating unit 2000 for the SAR image in accordance with the second embodiment will now be described. The 3D image generating unit 2000 includes an interference phase processor 2020, an extraction processor 2040, and a signal synthesizer 1090. The interference phase processor 2020 and the extraction processor 2040 are different from those units of the first embodiment whereas the signal synthesizer 1090 has the same process configuration as that of the first embodiment. Unlike the first embodiment, the extraction processor 2040 receives an off-nadir angle 2010 instead of the orbital coordinate information on the sensor. The off-nadir angle 2010 represents the direction of the radio wave radiation from the sensor of the SAR and is assumed to have the same value for all the received SAR images.

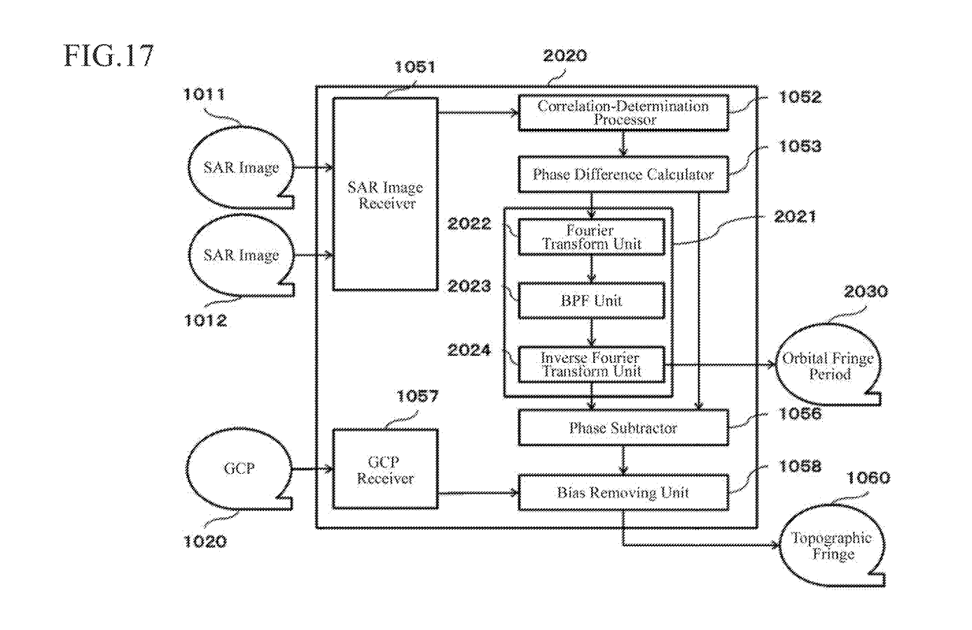

FIG. 17 is a functional block diagram illustrating the functions of the interference phase processor 2020. With reference to FIG. 17, the functions of the interference phase processor 2020 will now be described. The interference phase processor 2020 includes an SAE image receiver 1051, a correlation-determination processor 1052, a phase difference calculator 1053, an orbital fringe period calculator 2021, a phase subtractor 1056, a GCP receiver 1057, and a bias removing unit 1058. The orbital fringe period calculator 2021 includes a Fourier transform unit 2022, a BPF unit 2023, and an inverse Fourier transform unit 2024. The configuration is different from that of the first embodiment in that the configuration includes the orbital fringe period calculator 2021. The configuration does not include an orbital coordinate receiver, but efficiently calculates an orbital fringe period 2030 at the orbital fringe period calculator 2021 instead of the orbital coordinate in formation.

In the orbital fringe period calculator 2021, the Fourier transform unit 2022 uses the data of the phase distribution from the data of the interference phase and the signal amplitude for each pixel of two SAR images received at the SAR image receiver 1051. The Fourier transform unit transforms the data of the phase distribution in the space domain to the data of the frequency distribution in the frequency domain by Fourier transform, where Fourier transform is performed in the range direction of SAR image in the space domain. The Fourier transform unit 2022 receives the SAR image 1011 and the SAR image 1012, and outputs the frequency distribution transformed from the phase distribution and the data of the amplitude of each pixel.

The BPF unit 2023 is a processing unit including a band pass filter (BPF) and extracts the frequency component having an orbital fringe period from the data of the frequency distribution transformed from the phase distribution at the Fourier transform unit 2022 and the amplitude of each pixel. The BPF unit 2023 receives the data of the frequency distribution transformed from the phase distribution and the amplitude of each pixel, and outputs the data of the frequency component having an orbital fringe period and the amplitude of each pixel without any change.

The inverse Fourier transform unit 2024 transforms the frequency component of the phase in a space domain to the space domain representation by inverse Fourier transform using the frequency component of the phase of the space domain calculated at the BPF unit 2023 and the data of the amplitude of each pixel. This process readily extracts only the phase distribution of the orbital fringe from the interference phase of each pixel outputted at the phase difference calculator 1053. The inverse Fourier transform unit 2024 receives the frequency component of the phase in the space domain and the data of the amplitude of each pixel, and outputs the phase distribution of the orbital fringe and the data of the amplitude of each pixel without any change.

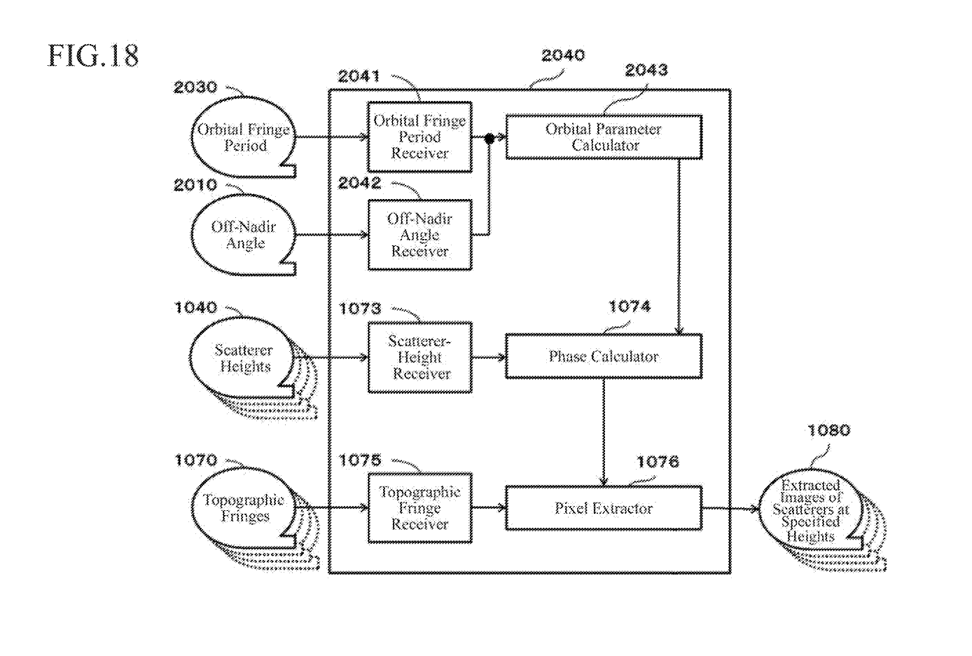

With reference to FIG. 18, the functions of the extraction processor 2040 will now be described. FIG. 18 illustrates a functional block diagram of the extraction processor 2040. The extraction processor 2040 includes an orbital fringe period receiver 2041, an off-nadir angle receiver 2042, an orbital parameter calculator 2043, a scatterer-height receiver 1073, a phase calculator 1074, a topographic fringe receiver 1075, and a pixel extractor 1076. The configuration includes the orbital fringe period receiver 2041 and the off-nadir angle receiver 2042, unlike the first embodiment. Although the configuration does not include the orbital coordinate receiver 1071 and the scatterer-height receiver 1073, the orbital parameter calculator 2043 calculates the orbital parameter using the information on the orbital fringe period and the off-nadir angle instead of the information on the orbital coordinates and the height of the scatterer. Like the orbital parameter calculator 1072 in the first embodiment, the orbital parameter calculator 2043 calculates the orbital parameter using the received data. The process of the orbital parameter calculator 2043 however differs from that of the orbital parameter calculator 1072 because the received data differs from that of the first embodiment.

The orbital fringe period receiver 2041 receives multiple orbital fringe periods 2030 from the interference phase processor 2020. Each of the received orbital fringe periods corresponds to each set of SAR images generating each topographic fringe received at the topographic fringe receiver 1075. The off-nadir angle receiver 2042 receives the off-nadir angle representing the direction of the radio wave radiation that has captured SAR images 1010. The orbital parameter calculator 2043 calculates each orbital parameter using the orbital cycle data corresponding to each topographic fringe received at the orbital parameter receiver 2041 and the off-nadir angle received at the off-nadir angle receiver 2042. The orbital parameter calculator 2043 receives the orbital cycle corresponding to each topographic fringe and the off-nadir angle, and outputs the orbital parameter corresponding to each topographic fringe.

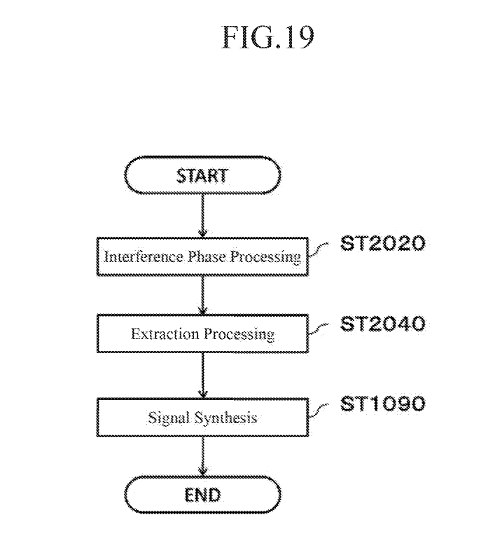

With reference to FIG. 19, the operation of a 3D image generating unit 2000 for the SAR image in accordance with the second embodiment will now be described. FIG. 19 is a flow chart illustrating the operation of the 3D image generating unit 2000 for the SAR image in accordance with the second embodiment.

As described in FIG. 13, the 3D image generating unit 2000 in accordance with the second embodiment has three major steps. In Step ST2020 (interference phase processing), the interference phase processor 2020 outputs the orbital fringe periods 2030 and the topographic fringes 1060 using the SAR images 1010 and the GCP data 1020. In Step ST2040 (extraction process), the extraction processor 2040 outputs extracted images 1080 using the orbital fringe periods 2030, the topographic fringes 1060, the off-nadir angle 2010, and the scatterer heights 1040. In Step ST1090 (signal synthesis), the signal synthesizer 1090 outputs a 3D SAR image using the extracted images 1080.

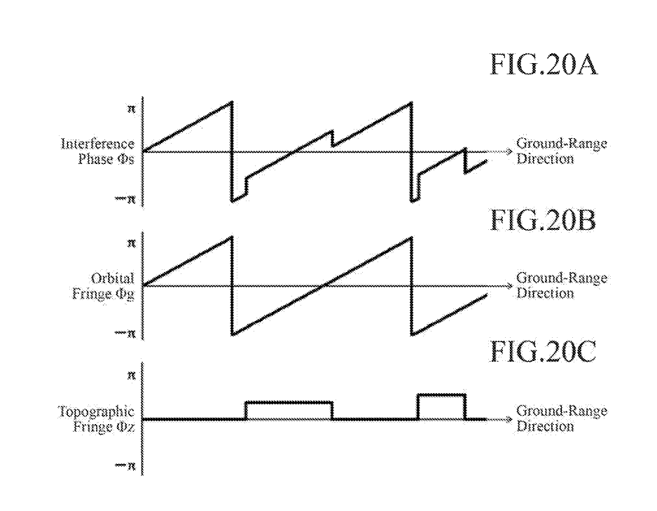

With reference to FIGS. 20A to 20C, the outline of the estimation of the orbital fringe in Step ST2020 (interference phase processing) will now be described. An object of Step ST2020 (interference phase processing) is to estimate the orbital fringe using two SAR images to generate the topographic fringe. A simplified estimation of the orbital fringe is described.

FIGS. 20A to 20C are graphs illustrating respective exemplary variations of the interference phase, the phase of the orbital fringe and the phase of the topographic fringe in the ground-range direction that are generated from two SAR images. FIG. 20A is a graph illustrating a diagram of the interference phase φs in the ground range direction (the direction from the ground track to the scatterer on the ground surface corresponding to the direction of the radio wave radiation) at an azimuth coordinate. The phase is wrapped by 2π and varies in a cycle. The cyclic variation of the interference phase φs in the ground range direction is caused by the orbital fringe φg, and the variation of the orbital fringe φg in the ground range direction can be described in FIG. 20B, The orbital fringe φg is removed from the interference phase φs as a component of the cyclic variation of the interference phase φs, and the corrected interference phase φc is extracted from the resulting difference (φs−φg) as illustrated in FIG. 20C.

For example, in a pixel in the SAR image, the complex number vn having an argument of the interference phase φs and an absolute value “1” is defined in Expression (11);

Vn=exp(j·φs) (11)

The complex number vn is transformed from the space domain to the frequency domain by Fourier transform. The variation of the interference phase φs in the space domain is transformed to the frequency domain representation to extract only the cyclic component having a peak through a band pass filter (BPF). For example, a peak frequency component is extracted from the frequency domain, and then transformed by inverse Fourier transform to define the variable component of the phase as an orbital fringe φg.

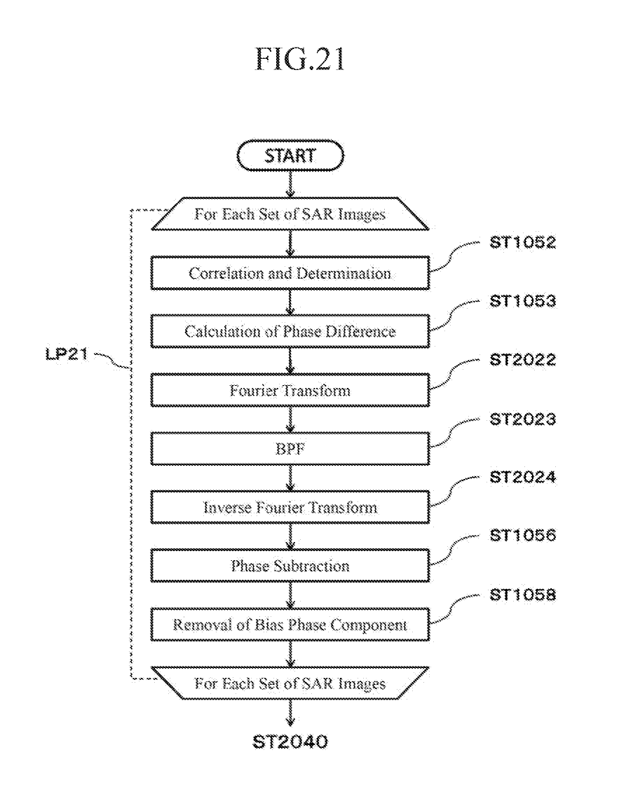

With reference to FIG. 21, the process of Step ST2020 (interference phase processing) will now be described in detail. FIG. 21 is a flow chart illustrating the process of Step ST2020 (interference phase processing). Since the phase of the orbital fringe is calculated from the data in the frequency domain of the interference phase of each pixel in the second embodiment, Step ST2020 (interference phase processing) includes Step ST2022, Step ST2023, and Step ST2024, unlike ST1050 (interference phase processing) in FIG. 7 of the first embodiment.

Step ST2022 (Fourier transform) receives the interference phase (the phase φs and the signal amplitude of the pixel) of each pixel calculated at Step ST1053 (calculation of phase difference). The Fourier transform unit 2022 transforms the data of the distribution of the phase φs in the interference phase in the space domain of SAR image by Fourier transform to calculate the frequency distribution of each interference phase in the space domain. For example, the complex number vn is defined to have an argument of the interference phase φs and an absolute value “1” as described in Expression (11), and the variation of the interference phase φs in the space domain is transformed to the frequency domain representation by Fourier transform.

In Step ST2023, the BPF unit 2023 receives the frequency distribution of the interference phase in the space domain calculated at Step ST2022 (Courier transform). The BPF unit 2023 performs the process of BPF. The BPF unit 2023 extracts the frequency component that has a primary cycle in the space domain from the frequency distribution of the interference phase φs in the space domain. For example, only a peak frequency is extracted from the frequency domain that represents an orbital fringe when the interference phase distribution in the space domain is transformed to the frequency domain representation. Since the cyclic phase distribution in the space domain in the interference phase φs calculated at Step ST1053 represents the orbital fringe, the frequency extracted through the process of BPF represents the frequency component of the orbital fringe φg.

Step ST2024 (inverse Fourier transform) receives the frequency component extracted at Step ST2023 (BPF) that has the primary cycle of the interference phase φs in the space domain. The inverse Fourier transform unit 2024 transforms the frequency component to the space domain representation by inverse Fourier transform. This process readily extracts the phase φg of the orbital fringe from the interference phase φs of SAR image outputted from the phase difference calculator 1053. At the same time, the process outputs the cycle Δx of a variation in the phase φg of the orbital fringe in the space domain. The cycle Δx of the orbital fringe is theoretically defined by Expression (12):

Δx=(λ·R·cos θ)/(p·B) (12)

After that, Step ST2020 performs the same process as Step ST1056 (phase subtraction) and Step ST1053 (removal of bias phase) described in FIG. 7 of the first embodiment to output a topographic fringe (the phase φz and the signal amplitude of the pixel). In the second embodiment, the orbital fringe can efficiently be calculated through the calculation of the interference phase and the phase of the orbital fringe for each pixel in the frequency domain.

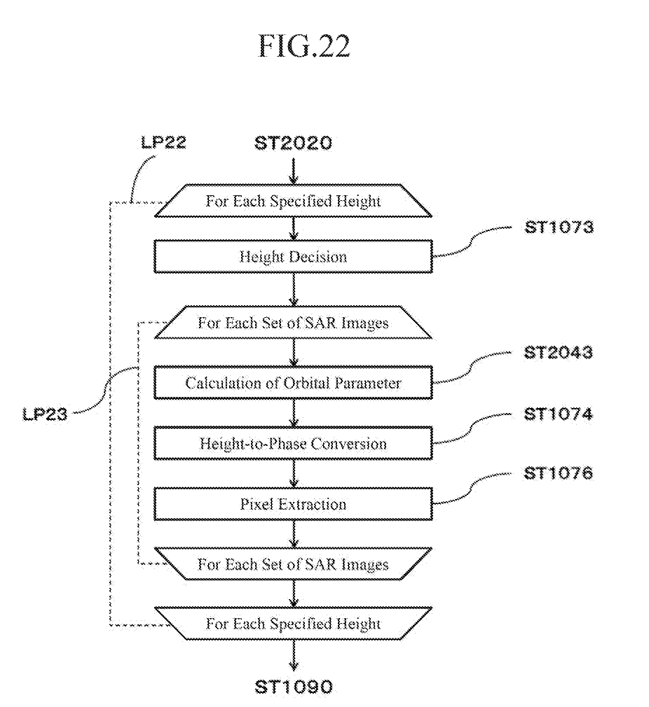

With reference to FIG. 22, the process of Step ST2040 (extraction-processing) will now be described in detail. FIG. 22 is a flow chart illustrating the process of Step ST2040 (extraction processing). The second embodiment described in FIG. 22 includes the orbital parameter calculating Step ST2043, unlike the first embodiment described in FIG. 12.

In Step ST2043 (calculation of orbital parameter), the orbital cycle receiver 2041 receives the orbital parameter Δx from the interference phase processor 2020, the off-nadir angle receiver 2042 receives the off-nadir angle θ representing the direction of the radio wave radiation that has captured SAR image, and then the orbital parameter calculator 2043 calculates the orbital parameter m. In the first embodiment, the orbital parameter m is defined by Expression (8);

m=2·πp·B/λ·R19 sin θ

In contrast, in the second embodiment, the orbital parameter m is defined by Expression (13) using the orbital fringe period Δx calculated by Expression (12):

m=1/(Δx·tan θ) (13)

Step ST2043 (calculation of orbital parameter) calculates the orbital parameter m by Expression (13).

In the second embodiment, the orbital fringe period Δx and the off-nadir angle θ are required to calculate the orbital parameter m by Expression (13). Since the orbital fringe period Δx is calculated from the SAR image, the second embodiment can calculate the orbital parameter for converting the height information to the specified phase without the high-accuracy orbital position information on the sensor.

Although the first embodiment requires the high-accuracy orbital position information on the sensor, the second embodiment does not require the high-accuracy orbital position information on the sensor. In detail, the second embodiment uses only the off-nadir angle of the radio wave radiation of the sensor information because the information on the orbital fringe of the SAR image calculated by Fourier transform is available, where the accuracy of the off-nadir angles of the radio wave radiation is not so dependent on the orbital position.

Like the first embodiment, the second embodiment uses multiple baseline lengths and multiple topographic fringes. One of the baseline lengths is called a first baseline length and the other baseline length is called a second baseline length. One of the topographic fringes corresponding to the first baseline length is called a first topographic fringe and the other topographic fringe corresponding to the second baseline length is called a second topographic fringe.

The synthetic-aperture radar signal processing apparatus 1 in accordance with the second embodiment is characterized in that the interference phase processor 2020 includes the orbital fringe period calculator 2021 calculating the orbital fringe period using the first set of two synthetic aperture radar images and the second set of two synthetic aperture radar images, the extraction processor 2040 includes the orbital parameter calculator 2043 calculating the orbital parameters corresponding to the first and second baseline lengths using the orbital fringe period calculated at the orbital fringe period calculator 2021 and the off-nadir angle of the radio wave radiated from the synthetic aperture radar for generating the synthetic aperture radar image, and the phase calculator 1074 calculates the first and second specific phases using the orbital parameters calculated at the orbital parameter calculator 2043. This configuration allows the synthetic-aperture radar signal processing apparatus 1 to calculate the specific phases without the orbital position information on the sensor with high accuracy.

The synthetic-aperture radar signal processing apparatus 1 in accordance with the second embodiment is characterized in that the orbital fringe period calculator 2021 selects a frequency based on the power distribution of the frequency component from the frequency spectrum that represents the spatial variation of the relative phase between signals contained in the two pixels of the first set of two synthetic aperture radar images or the second set of two synthetic aperture radar images, and extract the selected frequency as a frequency corresponding to the orbital fringe period. Examples of methods for selecting a frequency from the frequency spectrum based on the power distribution of the frequency component include one configuration that selects a peak frequency from the frequency spectrum. This configuration allows the synthetic-aperture radar signal processing apparatus 1 to efficiently extract the orbital fringe period using the two synthetic aperture radar images, i.e., the first set of two synthetic aperture radar images or the second set of two synthetic aperture radar images.

### Third Embodiment

The first and second embodiments require the information on the sensor that includes the orbital position information (e.g. the orbital coordinates of artificial satellite) of the sensor capturing SAR image and the off-nadir angle of the radio wave radiation. In contrast, the third embodiment can be performed even if the information on the sensor is not available. In addition to multiple SAR images that have the different baselines, the third embodiment uses the data of GCP (the standard point on the ground, i.e., Ground Control Point) at specified heights, instead of the information on the sensor to extract scatterers at the same heights as the scatterers of the GCP at the specified heights from the SAR image. In the following descriptions, the same reference numerals used In the first and second embodiments are assigned to the same input data, output data, units and steps without redundant description.

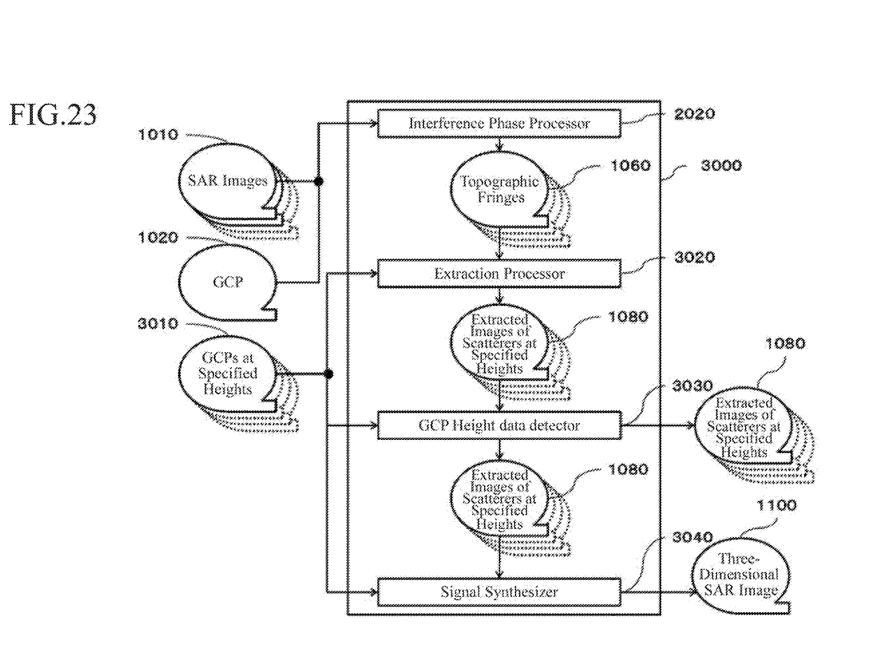

FIG. 23 is an overall configuration diagram of a device that extracts scatterers at the same height in the SAR image in accordance with the third embodiment. With reference to FIG. 23, the outline of an extraction unit 3000 of scatterers at the same height in the SAR image in accordance with the third embodiment (hereinafter a “scatterer extracting unit 3000”) will now be described.

The scatterer extracting unit 3000 includes a GCP-height data detector in addition to the interference phase processor, the extraction processor, and the signal synthesizer, unlike the first and second embodiments. In detail, the scatterer extracting unit 3000 includes an interference phase processor 2020, an extraction processor 3020, a GCB-height data detector 3030, and an extracted signal synthesizer 3040. The interference phase processor 2020 is the same unit as that of the second embodiment whereas the extraction processor 3020 and the GCP-height data detector 3030 have different configurations from those of the first and second embodiments.

Unlike the first and second embodiments, the extraction processor 3020 in the third embodiment receives the topographic fringes 1060 of the interference phases and the GCPs-at-specified-heights 3010 instead of the information on the sensor. The GCP-height data detector 3030 also receives the GCPs-at-specified-heights 3010 in addition to the extracted images 1080. The GGP-height data detector 3030 determines whether the GCP-at-specified-height 3010 includes the information on the height of the scatterer. In the case where the GCP-at-specified-height 3010 does not include the information on the height of the scatterer, the GCP-height data detector outputs the extracted images 1080, and stops the process of the scatterer extracting unit 3000. In the case where the GCP-at-specified-height 3010 includes the information on the height of the scatterer, the GCP-height data detector outputs the extracted images 1080 to the extracted signal synthesizer 3040. The extracted signal synthesizer 3040 then receives the extracted images 1080 and the GCPs-at-specified-heights 3010, and outputs a three-dimensional SAR image 1100.

The GCP-at-specified-height 3010 includes the coordinates of the pixels in SAR image that correspond to the scatterers to be extracted at user-specified heights. The pixels of the scatterers are assumed to have no signal overlapping due to some reasons such as layover. In the case where the heights of the scatterers of the pixels are known, the GCP-at-specified-height 3010 includes the information on the heights of the scatterers. In the case where the heights of the scatterers of the pixels at the GCPs-at-specified-heights 3010 are unknown, the GCPs-at-specified-heights 3010 do not include the information on the heights of the scatterers.

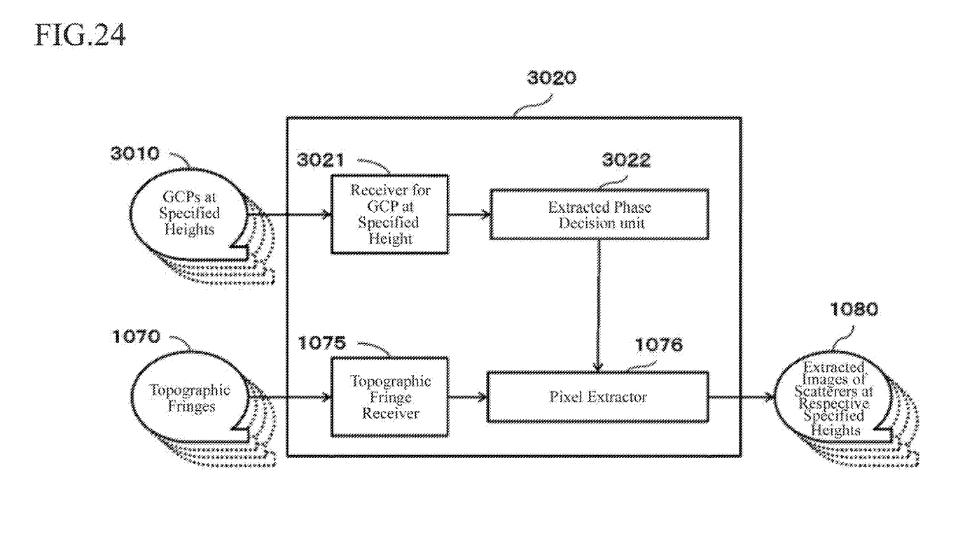

FIG. 24 is a functional block diagram illustrating the functions of the extraction processor 3020. With reference to FIG. 24, the functions of the extraction processor 3020 will now be described. The extraction processor 3020 includes a GCP-at-specified-height receiver 3021, an extracted phase decision unit 3022, a topographic fringe receiver 1075, and a pixel extractor 1076. The configuration includes the GCP-at-specified-height receiver 3021 and the extracted phase decision unit 3022, which are not included in the second embodiment. The configuration includes none of the orbital fringe period receiver, the off-nadir angle receiver, the scatterer height receiver, the orbital parameter calculator and the phase calculator. The extraction processors in the first and second embodiments convert the specified height to the selected phase using the orbital parameter m by Expression (9). In contrast, the extraction processor 3020 in the third embodiment performs neither the calculation of the orbital parameter nor the conversion process from the height information to the phase information by Expression (9) because the extraction processor directly determines the selected phase based on the phase of the pixel of the GCP at the specified height.

The GCP-at-specified-height receiver 3021 receives the GCPs-at-specified-heights 3010. The GCP-at-specified-height 3010 includes the data on the coordinates of the pixel in the SAR image and the data on the height of the pixel if the height of the scatterer at the coordinates is known. The extracted phase decision unit 3022 identifies the phase on the topographic fringe of the pixel for each set of SAR images generating the topographic fringe using the coordinates of the pixels of the GCP in the SAR image received at the GCP-at-specified-height receiver 3021, and determines the phase to be extracted at the pixel extractor 1076. The extracted phase decision unit receives the GCP-at-selected-height 3021 and outputs the phase of the topographic fringe of the pixel.

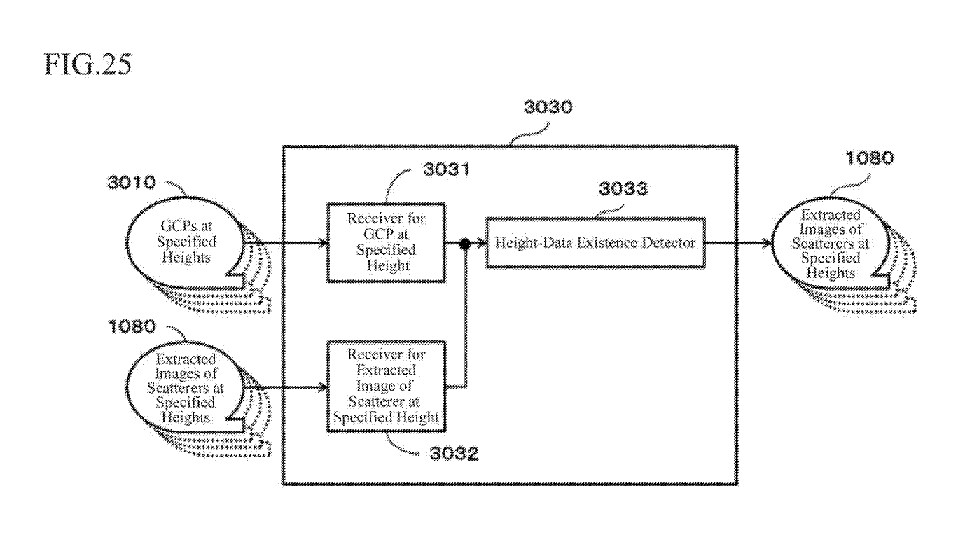

FIG. 25 is a functional block diagram illustrating the functions of the GCP-height data detector 3030. With reference to FIG. 25, the functions of the GCP-height data detector 3030 will now be described. The GCP-height data detector 3030 includes an GCP-at-selected-heights receiver 3031, a receiver 3032 of an extracted image of a scatterer at a specified height (hereinafter an “extracted image receiver 3032”) and a height-data existence detector 3033.

The GCP-at-specified-height receiver 3031 receives the GCPs-at-specified-heights 3010. The GCP-at-specified-height 3010 includes the data on the coordinates of the pixel in the SAR image, and the data on the height of the pixel if the height of the scatterer at the coordinates is known. The extracted image receiver 3032 receives the extracted images 1080 from the extraction processor 3020. The height-data existence detector 3033 determines whether the height of the scatterer of the pixel is known and whether the information on the height of the scatterer is included at the GCP-at-specified-height 3010 based on the GCP-at-specified-height 3010 received at the GCP-at-specified-height receiver 3031 and the extracted images 1080 received at the extracted image receiver 3032. In the case where the height of the scatterer is known or the information on the height of the scatterer is included at the GCP-at-specified-height 3010, the height data determining unit outputs the extracted images 1080 to the following signal synthesizer 3040 to proceed the process. In the case where the height of the scatterer is unknown or the information on the height of the scatterer is not included at the GCP-at-specified-height 3010, the height data determining unit outputs the extracted images 1080 and stops the process of the scatterer extracting unit 3000.

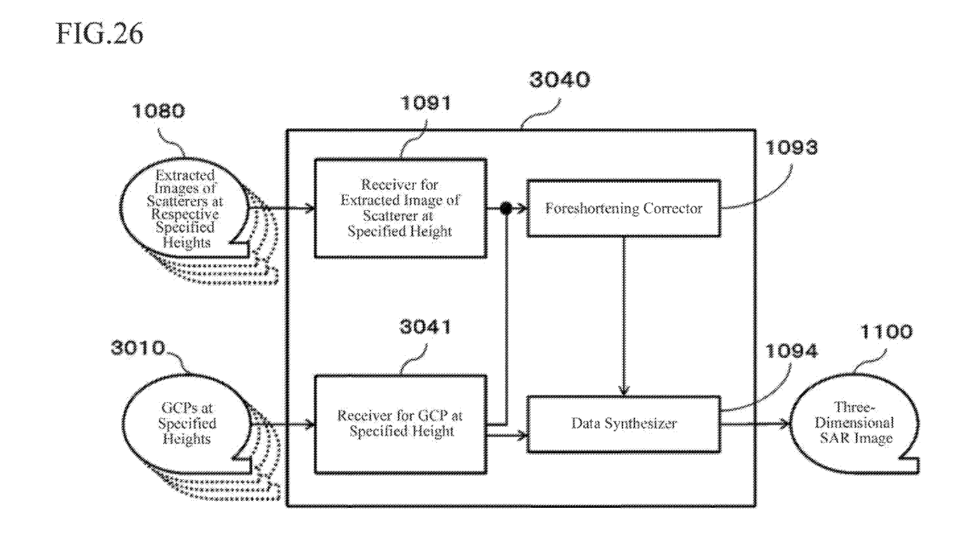

FIG. 26 is a functional block diagram illustrating the functions of the signal synthesizer 3040. with reference to FIG. 26, the functions of the signal synthesizer 3040 will now be described. The extracted signal synthesizer 3040 performs the process after the extracted images 1080 are received from the GCP-height data detector 3030.

The signal synthesizer 3040 includes an extracted image receiver 1091, a foreshortening corrector 1093, a GCP-at-specified-height receiver 3041, and a data synthesizer 1094. The signal synthesizer includes the GCP-at-specified-height receiver 3041 instead of the scatterer-height receiver 1092, unlike the first embodiment described in FIG. 4.

The GCP-at-specified-height receiver 3041 receives the height of the scatterer contained in the data on the coordinates of the pixel at the GCP-at-specified-height 3010. The data on the height of the scatterer contained in the data on the coordinates of the pixel at the GCPs-at-specified-heights 3010 correspond to the extracted images 1080 received at the extracted image receiver 1091.

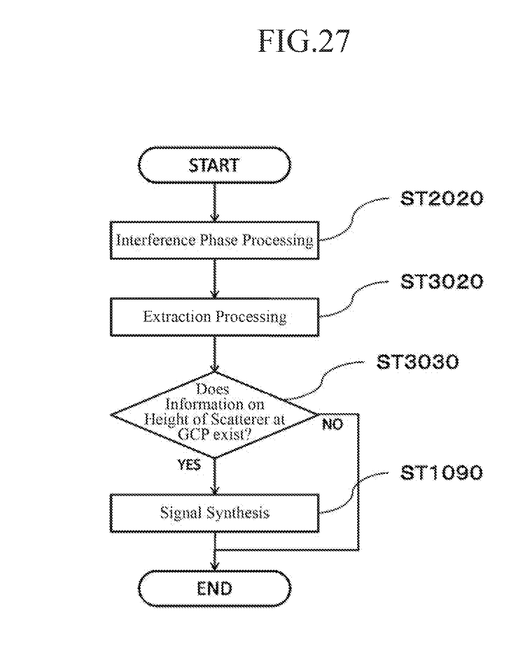

With reference to FIG. 27, the operation of the scatterer extracting unit 3000 for the SAR image in accordance with the third embodiment will now be described. FIG. 27 is a flow chart illustrating the operation of the scatterer extracting unit 3000 for the SAR image in accordance with the third embodiment. As described in FIG. 27, the scatterer extracting unit 3000 for the SAR image in accordance with the third embodiment has four major steps. Step ST2020 is the same process as that of the second embodiment described in FIG. 21 and Step ST1090 is the same processing as that or the first embodiment described in FIG. 15. The detailed descriptions of these two steps are thereby not provided.

In Step ST3020 (extraction process), the extraction processor 3020 extracts the scatterers at the same height as the GCP at the specified heights based on the GCPs-at-specified-heights 3010 and the topographic fringes 1060 to output the extracted images 1080. In Step ST3030 (the determination of the existence or non-existence of the information on the height of the scatterer at the GCP), the GCP-height data detector detects the existence or not-existence of the information on the height of the scatterer in the pixels at the GCPs-at-specified-heights 3010. If the information on the height of the scatterer is available, Step ST3040 is then performed. If the information on the height of the scatterer is not available, the process of scatterer extracting unit 3000 is stopped.

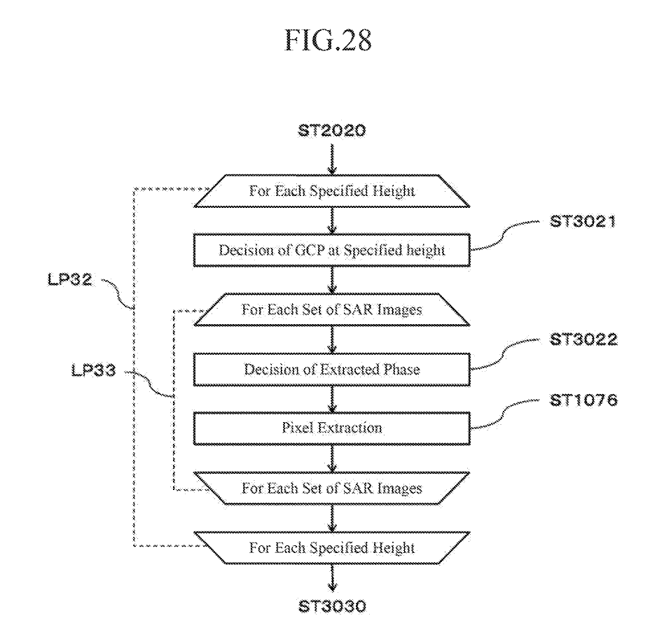

With reference to FIG. 28, the process of Step ST3020 (extraction processing) will now be described in detail. FIG. 28 is a flow chart illustrating the process of Step ST3020 (extraction processing). In order to directly determine the phase φz0 from the GCP at the specified height, the phase extraction processing of the third embodiment includes a GCP-at-selected-height decision step (ST3021) and an extracted phase decision step (ST3022) instead of the height decision step, the orbital parameter decision step, and the height-to-phase conversion step, unlike the phase extract ion processing of the first embodiment in FIG. 12.

Step ST3021 (decision of the GCP at a specified height) receives the coordinates of the GCP at the specified height inputted by a user at the GCP-at-specified-height receiver 3021. Step ST3022 (decision of extracted phase) identifies the phase φz0 of the pixel for each set of the SAR images using coordinates of the GCP selected in Step ST3021, and decides the phase φz0 to be extracted at the pixel extractor 1076. Step ST3022 receives the coordinates of the GCP at the specified height and directly decides the phase φz0 for the specified height in the SAR image without the conversion process with the orbital parameter.

As described above, the third embodiment selects a pixel having a phase corresponding to the height for each set of two SAR images using the data on the interference phase and the amplitude of the SAR images having multiple baselines, and thus can extract the scatterers at the same height. In the case where the GGP-at-specified-height 3010 does not include the information on the height of the scatterer, the scatterer extracting unit 3000 extracts only the scatterers at the same height as the GCP-at-specified-height 3010. In the case where the GCP-at-specified-height 3010 includes the information on the height of the scatterer, the scatterer extracting unit overlays and synthesizes the extracted images 1080 at the heights of the scatterers, generating a 3D SAR image like the first and second embodiments.

Since the third embodiment uses multiple GCPs at multiple heights in the SAR image, the third embodiment can eliminate the calculation of the orbital parameter for converting the specified height to the phase φz0 to be extracted, and can perform the processes without the orbital position information on the sensor, unlike the first and second embodiments.

The synthetic-aperture radar signal processing apparatus 1 in accordance with the third embodiment is characterized in that the extraction processor 1070 selects at least one pixel representing the scatterer at a known height, and extracts a scatterer at the same height as the known height. In particular, the at least one pixel at the GCP-at-specified-height 3010 can constitute a part or all of the pixels at the GCP 1020. This configuration allows the synthetic-aperture radar signal processing apparatus 1 to extract the SAR images at the specified heights without the orbital position information on the sensor.

### REFERENCE SIGNS LIST

1: synthetic-aperture radar signal processing apparatus, 1000: 3D image generating unit, 1010: SAR images, 1011: SAR: image, 1012; SAR image, 1020: GCP, 1030: orbital coordinates, 1040: scatterer heights, 1050: interference phase processor, 1051: SAR image receiver, 1052: correlation-determination processor, 1053: phase difference calculator, 1054: orbital coordinate receiver, 1055: orbital fringe calculator, 1056: phase subtractor, 1057: GCP receiver, 1058: bias removing unit, 1060: topographic fringe, 1070: extraction processor, 1071: orbital coordinate receiver, 1072: orbital parameter calculator, 1073: scatterer-height receiver, 1074: phase calculator, 1075: topographic fringe receiver, 1076: pixel extractor, 1080: extracted image of scatterer at specified height, 1030: signal synthesizer, 1091: receiver of extracted image of scatterer at specified height, 1092: foreshortening corrector, 1093: data synthesizer, 1094: data synthesizer, 1100: three-dimensional SAR image, 1200; scatterer-height estimating unit, 2000: 3D image generating unit, 2010: off-nadir angle, 2020: interference phase processor, 2021: orbital fringe period calculator, 2022: Fourier transform unit, 2023: BPF unit, 2024: inverse Fourier transform unit, 2030: orbital fringe period, 2040: extraction processor, 2041: orbital fringe period receiver, 2042: off-nadir angle receiver, 2043: orbital parameter calculator, 3010: GCP-at-specified-height, 3020: extraction processor, 3021: GCP-at-specified-height receiver, 3022: extracted phase decision unit, 3030: GCP-height data detector, 3031: GCP-at-specified-height receiver, 3032: receiver of extracted image of scatterer at specified height, 3033: height-data existence detector, 3040: signal synthesizer, and 3041: GCP-at-specified-height receiver.

1. A synthetic-aperture radar signal processing apparatus comprising:
an interference phase processor to calculate
a first topographic fringe represented by multiple pixels, representing a relative phase between signals contained in two pixels representing a same scatterer in a first set of two synthetic aperture radar images using the first set of two synthetic aperture radar images generated by two sensors having a first baseline length, and
a second topographic fringe represented by multiple pixels, representing a relative phase between signals contained in two pixels representing the same scatterer in a second set of two synthetic aperture radar images using the second set of two synthetic aperture radar images generated by two sensors having a second baseline length; and
an extraction processor including
a phase calculator to calculate a first specific phase that corresponds to a scatterer at at least one specific height in the first topographic fringe and a second specific phase that corresponds to the scatterer at said at least one specific height in the second topographic fringe, and
a pixel extractor to extract a pixel corresponding to said at least one specific height from the first topographic fringe and the second topographic fringe, the pixel having the first specific phase in the first topographic fringe and the second specific phase in the second topographic fringe, the first and second topographic fringes being calculated by the interference phase processor.

2. The synthetic-aperture radar signal processing apparatus according to claim 1, wherein said at least one specific height is higher than a specific height measurable by only two sensors having a shorter one of the first baseline length and the second baseline length.

3. The synthetic-aperture radar signal processing apparatus according to claim 1, wherein the interference phase processor includes a bias removing unit to select at least three pixels representing scatterers at a same known height in the first or second set of two synthetic-aperture radar images, and to correct the phases of the pixels in the first or second set of two synthetic aperture radar images such that the phases of the signals contained in the at least three pixels have a same value in the first or second set of two synthetic aperture radar images.

4. The synthetic-aperture radar signal processing apparatus according to claim 1, wherein:
the extraction processor further includes an orbital parameter calculator to calculate orbital parameters corresponding to tie first baseline length and the second baseline length from orbital information on the two sensors having the first baseline length and the two sensors haying the second baseline length; and
the phase calculator calculates the first specific phase and the second specific phase with the orbital parameters calculated by the orbital parameter calculator.

5. The synthetic-aperture radar signal processing apparatus according to claim 1, wherein:
the interference phase processor includes aa orbital fringe period calculator to calculate an orbital fringe period from the first set of two synthetic aperture radar images and the second set of two synthetic aperture radar images;
the extraction processor includes an orbital parameter calculator to calculate orbital parameters corresponding to the first baseline length and the second baseline length with the orbital fringe period calculated by the orbital fringe period calculator and an off-nadir angle of radio waves radiated from a synthetic aperture radar for generating the synthetic aperture radar image; and
the phase calculator calculates the first specific phases and the record specific phases with the orbital parameters calculated by the orbital parameter calculator.

6. The synthetic-aperture radar signal processing apparatus according to claim 5, wherein the orbital fringe period calculator selects a frequency based on a power distribution of frequency components from a frequency spectrum that represents a spatial variation in a relative phase between signals contained in the two pixels of the first or second set of two synthetic aperture radar images, and extracts the selected frequency as a frequency corresponding to the orbital fringe period.

7. The synthetic-aperture radar signal processing apparatus according to claim 3, wherein the extraction processor selects at least one pixel representing a scatterer at a known height, and extracts another scatterer at the same height as the known height of the scatterer contained in the selected pixel.

8. The synthetic-aperture radar signal processing apparatus according to claim 1, wherein it is indicated to determine whether the two pixels include a reflected signal containing a single signal component or reflected signal containing multiple signal components on a basis of a temporal or spatial variation in a phase difference between the two pixels representing the same scatterer in the first or second set of two synthetic aperture radar images.

9. The synthetic-aperture radar signal processing apparatus according to claim 1, wherein:
said at least one specific height includes a plurality of specific heights;
the pixel extractor extracts the pixels corresponding to the specific heights; and
the synthetic-aperture radar signal processing apparatus further comprises a signal synthesizer to generate a three-dimensional image with the pixels at the specific heights extracted by the pixel extractor.

10. The synthetic-aperture radar signal processing apparatus according to claim 2, wherein the interference phase processor includes a bias removing unit to select at least three pixels representing scatterers at a same known height in the first or second set of two synthetic aperture radar images, and to correct the phases of the pixels in the first or second set of two synthetic aperture radar images such that the phases of the signals contained in the at least three pixels have a same value in the first or second set of two synthetic aperture radar images.

11. The synthetic-aperture radar signal processing apparatus according to claim 2, wherein:
the extraction processor further includes an orbital parameter calculator to calculate orbital parameters corresponding to the first baseline length and the second baseline length from orbital information on the two sensors having the first baseline length and the two sensors having the second baseline length; and
the phase calculator calculates the first specific phase and the second specific phase with the orbital parameters calculated by the orbital parameter calculator.

12. The synthetic-aperture radar signal processing apparatus according to claim 2, wherein:
the interference phase processor includes an orbital fringe period calculator to calculate an orbital fringe period from the first set of two synthetic aperture radar images and the second set of two synthetic aperture radar images;
the extraction processor includes an orbital parameter calculator to calculate orbital parameters corresponding to the first baseline length and the second baseline length with the orbital fringe period calculated by the orbital fringe period calculator and an off-nadir angle of radio waves radiated from a synthetic aperture radar for generating the synthetic aperture radar image; and
the phase calculator calculates the first specific phases and the second specific phases with the orbital parameters calculated by the orbital parameter calculator.

13. The synthetic-aperture radar signal processing apparatus according to claim 12, wherein the orbital fringe period calculator selects a frequency based on a power distribution of frequency components from a frequency spectrum that represents a spatial variation in a relative phase between signals contained in the two pixels of the first or second set of two synthetic aperture radar images, and extracts the selected frequency as a frequency corresponding to the orbital fringe period.
